(19) United States
(12) Patent Application Publication
(10) Pub. No.: US 2026/0229166 A1
(43) Pub. Date: Aug. 6, 2026

(54) METHOD OF DRIVING AND CALIBRATING A DISPLAY DEVICE COMPRISING A VARIABLE-WAVELENGTH LED

(71) Applicant: PORO TECHNOLOGIES LTD, Cambridge, Cambridgeshire (GB)

(72) Inventor: Edward BUCKLEY, Cambridge (GB)

(73) Assignee: PORO TECHNOLOGIES LTD, Cambridge, Cambridgeshire (GB)

(21) Appl. No.: 19/152,689

(22) PCT Filed: Feb. 1, 2024
(86) PCT No.: PCT/GB2024/050286

§ 371 Date: Jul. 31, 2025

(30) Foreign Application Priority Data
Feb. 1, 2023 (GB) 2301483.0
Jun. 27, 2023 (GB) 2309693.6

(51) Int. Cl. G09G 3/32; G09G 3/20

(52) U.S. Cl. CPC G09G 3/32; G09G 3/2022; G09G 2320/0242; G09G 2320/0693

(57) ABSTRACT

A method of driving a display device comprising a variable-wavelength LED is provided. The variable-wavelength LED is a pixel of the device, or one of a plurality of subpixels of a device pixel, and the display device is programmed to operate using a palette of N available primary emission wavelengths AR, wherein each of the N available primaries is a wavelength emittable by the variable-wavelength LED. The variable-wavelength LED is driveable to emit light at any of the N available primary emission wavelengths A? in response to N respective subfields of driving conditions. The method comprises the steps of: identifying an output signal to be displayed by a pixel, or a subpixel, of the display device during a display frame; selecting a pair of two of the N available primary emission wavelengths which are combinable to form the output signal; and driving the pixel or subpixel to emit light at the two selected primary emission wavelengths during two subframes within the display frame, so that the light emitted at the two selected primary emission wavelengths during the display frame combines to form the output signal with an output chromaticity and output luminance Lo. A method of calibrating the display device comprises the steps of: selecting a pair of two discrete primary emission wavelengths A?, each primary emission wavelength A? corresponding to a respective subfield of driving conditions; calculating, for the two selected primary emission wavelengths, the respective luminances which sum to a standard illuminant point; and controlling the durations of the respective duty cycles of the two subfields driving the two selected primary emission wavelengths so that the selected primary emission wavelengths A? and luminances of both selected primary emission wavelength subfields are complementary and sum to a standard illuminant point.

The present invention relates to a method of driving a display device comprising a variable-wavelength LED, and a method of calibrating a display device comprising a variable-wavelength LED. In particular, the invention relates to a method of calibrating and driving a display device using two primary emission wavelengths.

### BACKGROUND

III-V semiconductor materials are of particular interest for semiconductor device design, in particular the family of III-nitride semiconductor materials.

“III-V” semiconductors include binary, ternary and quaternary alloys of Group III elements, such as Ga, Al and In, with Group V elements, such as N, P, As and Sb, and are of great interest for a number of applications, including electronics and optoelectronics.

Of particular interest is the class of semiconductor materials known as “III-nitride” materials, which includes gallium nitride (GaN), indium nitride (InN) and aluminium nitride (AlN), along with their ternary and quaternary alloys. (Al,In) GaN is a term encompassing AlGaN, InGaN and GaN. III-nitride materials have not only achieved commercial success in solid-state lighting and power electronics, but also exhibit particular advantages for quantum light sources and light-matter interaction.

While a variety of III-nitride materials are commercially interesting, Gallium nitride (GaN) is widely regarded as one of the most important new semiconductor materials, and is of particular interest for a number of applications.

The present invention will be described primarily by reference to GaN and InGaN, but may advantageously be applicable to alternative III-nitride material combinations.

It is known that the introduction of pores into bulk III-nitrides, such as GaN can profoundly affect its material properties (optical, mechanical, electrical, and thermal, etc.). The possibility of tuning a wide range of material properties of GaN and III-nitride semiconductors by altering its porosity therefore makes porous GaN of great interest for optoelectronic applications.

In a significant improvement over conventional three-colour LED displays, Poro Technologies Ltd, the present applicant, has developed variable-wavelength LEDs formed from III-nitride semiconductor materials grown over a porous region of III-nitride material. Instead of a conventional LED which emits at a single colour, these variable-wavelength LEDs can emit a broad spectrum of different emission wavelengths in response to varying the driving conditions provided to the variable-wavelength LED. These variable-wavelength LEDs, and their method of manufacture, are set out below.

As the peak emission-wavelength of such variable-wavelength LEDs can be tuned by varying the driving conditions, a single variable-wavelength LED can take the place of multiple “single-colour” subpixels. In particularly preferred embodiments, the same variable-wavelength LED can be tuned to emit any one of red, green or blue light by tuning the driving conditions provided to that LED. This means that a colour display can be formed from an array of variable-wavelength LEDs, with each variable-wavelength LED acting as a colour-variable pixel, or alternatively as a colour-variable subpixel in a subpixellated display.

The ability of variable-wavelength LEDs to emit such a broad range of emission wavelengths makes display driving and calibration processes significantly more complex than it would be for a conventional RGB subpixel display. The peak emission wavelength of the variable-wavelength LEDs is strongly dependent on the magnitude of the electrical driving signal provided to a given LED, and longer-wavelength emission colours require lower-magnitude driving currents/voltages which inherently produce a lower luminance. This presents a challenge for colour-mixing, as it is desirable to maintain colour balance between primary emission wavelengths with inherently different luminances.

### SUMMARY OF INVENTION

The present application relates to a method of driving a display device comprising a variable-wavelength light emitting diode (LED), and a method of calibrating a display device comprising a variable-wavelength light emitting diode (LED). The method may advantageously be used to drive a display device comprising a plurality of such variable-wavelength LEDs, for example an array of such LEDs.

The invention is defined in the independent claims, to which reference should now be made. Preferred or advantageous features of the invention are defined in the appended sub-claims.

The present invention is preferably carried out with a display device comprising a plurality of variable-wavelength LEDs. In preferred embodiments, such display devices comprise an array of variable-wavelength LEDs, with each variable-wavelength LED forming a pixel of the display device.

An example of variable-wavelength LEDs usable in the present invention are known as dynamic-pixel-tuning (DPT®) variable-wavelength LEDs from Poro Technologies Ltd, which are discussed in detail below.

A continuum of different emission wavelengths across an emission wavelength range can be emitted directly from a variable-wavelength LED by varying the driving conditions (the magnitude of the driving current and/or driving voltage) supplied to that LED. In CIE xy colourspace, the variable-wavelength LED can emit any colour along a continuous curved line of wavelengths. The length and shape of the emittable-wavelengths line in CIE xy colourspace is determined by the LED composition and structure, as described below.

One way of controlling the wavelength of light emitted by a variable-wavelength LED would be to provide a continuously-variable driving current to the LED. When the display device receives a signal identifying the target colour to be displayed by a given variable-wavelength LED, the driving current to that pixel could then be delivered at whatever magnitude is required for the LED to emit a particular wavelength from its continuum of emittable wavelengths. Downsides of this approach, however, are the difficulty of precisely controlling the variable driving current at all times, and the limitation that the variable-wavelength LED could only display chromaticities which are on the continuous line of emission wavelengths directly-emittable by that LED.

An alternative approach to driving variable-wavelength LEDs is to choose a set of pre-determined “primaries” (primary wavelengths) from the continuum of emission wavelengths which are emittable by the variable-wavelength LED. Instead of controlling the emission wavelength to any point across the entire range of emittable colours, a limited set of operating points can be created by selecting a plurality of N primary wavelengths from the range of emittable colours. Each of the N primaries is then used as a pre-determined operating point for the variable-wavelength LED, and the N respective driving conditions required to generate those N primary wavelengths are programmed into a display device incorporating the variable-wavelength LED.

The N primary wavelengths which are selected from the LED's range of emittable wavelengths form a palette of N available primaries, so that at any time the variable-wavelength LED can be controlled to emit light at one of these N predetermined primary wavelengths. The N available primaries define a colour gamut of a plurality of displayable colours, as any colour within this gamut can be displayed by the variable-wavelength LED by mixing the available primary wavelengths.

When the display device receives a signal identifying the target colour to be displayed by a given variable-wavelength LED, the device can select, out of the palette of N available primaries, a smaller set of 2 or more primaries which are mixable to render the target colour. Which primaries are selected from the N available primaries will depend on the wavelength of the target colour to be displayed.

By driving the LED to emit light at only a plurality of “primary” wavelengths instead of any wavelength from the continuum of directly-emittable wavelengths, the display device can display additional chromaticities which are not directly-emittable by the variable-wavelength LED. Primary wavelengths can be mixed using colour-mixing techniques known for conventional displays, such that the overall colour observed by a viewer is a temporal and/or spatial combination of the emitted primaries, rather than a single colour which is emitted “directly” by a single variable-wavelength LED. Driving variable-wavelength LEDs to emit light at predetermined “primary” wavelengths may also advantageously simplify driving requirements, as instead of having to provide a continuously-variable driving current, the display device can be calibrated to deliver a more manageable set of N pre-determined driving conditions which generate the N available primaries.

The number “N” of available primaries can be selected depending on the size of the colour gamut which is desired, and the desired complexity of the control system. The larger the number of N, the larger the displayable colour gamut, but the larger the number of required driving conditions and the more complex the control requirements. As the variable-wavelength LED can emit a continuous range of wavelengths, N can be selected to be any number up to infinity (N=infinity being equivalent to continuous driving to any point within the range of emittable wavelengths). N is preferably greater than 3, so that the displayable colour gamut is sufficiently large to render a wide range of colours. Particularly preferably N is greater than or equal to 4, or 5, or 6, to encompass a large colour gamut while keeping the control requirements relatively straightforward. Preferably N may be less than or equal to 8, or 10, or 12, to prevent the control requirements from becoming overly complex.

In a preferred embodiment of a display device, each variable-wavelength LED is a pixel of the device, and the display device is a field-sequential display. In this embodiment, the same variable-wavelength LED pixel is driven to emit a plurality of discrete primary emission wavelengths in sequential subframes, by driving the LED pixel with the discrete driving conditions which correspond to those primary wavelengths.

In a sequential-field display, the same variable-wavelength LED may be controlled to emit multiple discrete primary emission wavelengths one after the other, by supplying different driving conditions to the LED in sequential subframes of a display frame. In this way, the same variable-wavelength LED may be a pixel that emits a plurality of selected “primary emission wavelengths” one after another within the duration of a single display frame. During each individual subframe, only one primary emission wavelength is emitted by the pixel. Thanks to the persistence of vision of human observers, the primary wavelengths emitted during sequential subframes temporally-average, so that the resulting colour observed by a person viewing the display at a normal viewing distance is the mixture of the colours emitted during a display frame.

In a subpixellated display, different primary emission wavelengths can be emitted by separate subpixels. The subpixels may all be variable-wavelength LEDs, or some subpixels may be non-variable-wavelength LEDs.

The brightness, or greyscale, of the emitted light can be varied by shortening or lengthening the duty cycle (pulse width) of the driving current pulses supplied to the LEDs in the display, which varies the “on time” of the LEDs. In a field-sequential display, the maximum duty cycle is achieved when the driving current is supplied to a variable-wavelength LED for 100% of the duration of the display frame, or subframe, allocated to the colour being emitted. While controlling the magnitudes of the driving currents provided to the variable-wavelength LEDs determines the emitted wavelengths, to achieve variable display brightness the duty cycles of the pulses of driving current must also be variable, which adds an additional layer of complexity to device control.

In Poro Technologies Ltd's dynamic-pixel-tuning (DPT®) variable-wavelength LEDs, the peak emission wavelength of variable-wavelength LEDs is strongly dependent on the magnitude of the electrical driving signal provided to a given LED, and longer-wavelength emission colours require lower-magnitude driving currents/voltages which inherently produce a lower luminance. This presents a challenge for those situations where a high display brightness is desired, and also a challenge for colour-balance when naturally-bright shorter wavelengths must be mixed with naturally-dimmer longer wavelengths.

In a first aspect of the present invention there is provided a method of driving a display device comprising a variable-wavelength LED. The display device may be programmed to operate using a palette of N available primary emission wavelengths λP, wherein each of the N available primaries is a wavelength emittable by the variable-wavelength LED. The variable-wavelength LED is driveable to emit light at any of the N available primary emission wavelengths within an emission wavelength range of the variable-wavelength LED in response to N respective subfields of driving conditions. The wavelength emitted by the variable-wavelength LED depends on the driving conditions provided to the LED, for example the magnitude of the driving current supplied to the LED by a driving circuit.

The variable-wavelength LED may be a pixel of the device, or one of a plurality of subpixels of a device pixel.

The method comprises the steps of identifying an output signal to be displayed by a pixel, or a subpixel, of the display device during a display frame; and selecting a pair of two of the N available primary emission wavelengths which are combinable to form the output signal.

The method comprises the steps of: driving the pixel or subpixels to emit light at the two selected primary emission wavelengths within a display frame, so that the light emitted at the two selected primary emission wavelengths forms the output signal with an output chromaticity and output luminance L_{O}.

Due to the persistence of vision of a human observer viewing the display device at a normal viewing distance, the observer will perceive all of the light emitted by the LED pixel or subpixel during the display frame averaging out to form the output signal. The perceived output chromaticity will be a temporal-average of the discrete primary emission wavelengths emitted during the display frame.

Driving the pixel or subpixel to emit light at the two selected primary emission wavelengths within a display frame may comprise providing two respective subfields of driving conditions to the pixel or subpixel.

The N available primaries may define a colour gamut of a plurality of displayable colours.

The display frame preferably consists of two subframes, in which one of the pair of selected primary emission wavelengths is emitted in each of the two subframes of the display frame. The wavelengths of the two primary emission wavelengths are variable, or varied, between display frames. The two selected primary emission wavelengths may be varied between display frames. For example if the chromaticity of the output signal to be displayed varies between display frames, the two primary wavelengths which are selected to create the output signal may be altered between display frames.

The two selected primary emission wavelengths are variable within the set of N available primary emission wavelengths. The two primary emission wavelengths are preferably variable within an emission wavelength range of the variable-wavelength LED.

The wavelengths of the two primary emission wavelengths selected for use in any given display frame are preferably selected to be complementary, such that the two primary emission wavelengths in the given display frame sum to a standard illuminant point.

The step of identifying an output signal to be displayed by the pixel, or subpixel, of the display device during a display frame may comprise receiving an input signal identifying a target colour to be displayed.

The step of selecting the pair of two of the N available primary emission wavelengths which are combinable to form the output signal may comprise selecting two primary emission wavelengths which are combinable to produce a given output chromaticity. The display device may be programmed to select pairs of primary emission wavelengths from a database which indexes output chromaticities to pairs of primary emission wavelengths.

In conventional display devices, desired colours of output signal are formed by combining emissions from three primaries (three light sources emitting at three discrete primary emission wavelengths). Using variable-wavelength LEDs, however, allows any colour of output signal to be produced using just a pair of two primaries from the available set of N primary emission wavelengths which can be emitted by the variable-wavelength LED.

Operation using only two primaries is more complicated than the typical 3-primary operation, but the present inventors have found that 2-primary control advantageously gives rise to an improved colour gamut compared to a 3-primary system.

In particular, the present inventors have appreciated that the process of changing the driving current magnitude supplied to a variable-wavelength LED is highly energy-intensive.

In a field-sequential display which drives the LED to emit a plurality of primaries sequentially within the same display frame, a higher number of primaries requires a higher number of driving current magnitudes, and more switching between the different driving current magnitudes. By driving the LED using only two primary emission wavelengths per display frame, however, it is only necessary to switch between two driving current magnitudes. While two-primary control is in some regards more complex than better-known three-primary processing, the use of two-primary field-sequential driving may advantageously reduce the power consumption of the display device.

The method of the present invention may be a method of driving a display device to display an output signal with a desired output chromaticity and output luminance by emitting only two primary emission wavelengths.

A subfield of driving conditions may alternatively be termed a set of driving conditions, referring to a specific condition of driving current and voltage which causes an LED to emit a corresponding wavelength of light.

The duty cycle of a subfield of driving conditions refers to the duration over which said driving condition is supplied to an LED (the “on time” of the LED), relative to the duration of a display frame, or a display subframe allocated to that subfield.

The step of driving the pixel or subpixels to emit light at two primary emission wavelengths within a display frame is achieved by providing driving conditions (for example an electrical driving current) to the pixel or subpixels. The properties of the subfield of driving conditions supplied to the variable-wavelength LED at any given time will determine the wavelength and associated luminance emitted by the variable-wavelength LED.

The step of driving the pixel to emit light at two primary emission wavelengths within a display frame may be achieved by driving the variable-wavelength LED in a field-sequential manner, so that discrete driving subfields are supplied in sequential subframes of the display frame and the variable-wavelength LED emits both primary emission wavelengths in a sequence within the display frame.

Alternatively the step of driving the subpixels to emit light at two primary emission wavelengths within a display frame may be achieved by driving the variable-wavelength LED subpixel to emit a first primary emission wavelength, and driving a separate subpixel (preferably a separate variable-wavelength LED subpixel) to emit a second primary emission wavelength.

The method may comprise driving the variable-wavelength LED with a first subfield of driving conditions for a first duty cycle to emit a first primary emission wavelength λ_{P1} of the device, with a first luminance L₁; and driving the variable-wavelength LED, or a separate LED subpixel of the display device, with a second subfield of driving conditions for a second duty cycle to emit a second primary emission wavelength λ_{P2} of the device, with a second luminance L₂. The light emitted at the first and second primary emission wavelengths combines to form an output signal with an output chromaticity and output luminance L_{O}.

The output chromaticity of the output signal may be a standard illuminant point. In order to arrive at a particular standard illuminant point, both the chromaticity and the luminance of the emitted primary emission wavelengths are preferably controlled, so that the colour-balance of the output signal matches the output signal which is desired to be displayed by the LED pixel or subpixel.

The wavelengths of the two primary emission wavelengths in any given display frame are preferably complementary such that the two primary emission wavelengths in the given display frame sum to a standard illuminant point. The wavelengths of the two primary emission wavelengths may be controlled by controlling the subfields of driving conditions supplied to drive the pixel or subpixels during the display frame.

The method may comprise the step of controlling the duty cycles of the driving conditions to control the luminances of the two selected primary emission wavelengths. Alternatively, the duty cycles of the subfields of driving conditions may be fixed for each primary emission wavelength in the palette of N available primary emission wavelengths.

Preferably the wavelengths and associated luminances of the two primary emission wavelengths in any given display frame are complementary such that the two primary emission wavelengths in the given display frame sum to a standard illuminant point. The luminances with which the two primary emission wavelengths are emitted may be controlled by controlling the duty cycles of the subfields of driving conditions supplied to drive the pixel or subpixels during the display frame. The method may further comprise adjusting the duty cycle of one or more driving subfields to control the luminance of one or both of the primary emission wavelengths, to maintain the white-balance of the output signal.

Although a continuum of different emission wavelengths are achievable by directly driving a variable-wavelength LED to emit a desired wavelength, additional chromaticities can be displayed by driving the LED to emit a plurality of “primary” wavelengths, such that the overall output signal observed by a viewer is a temporal combination of the emitted primaries.

In a subpixellated display, different primary emission wavelengths can be emitted by separate subpixels. The subpixels may all be variable-wavelength LEDs, or some subpixels may be non-variable LEDs.

In a sequential-field display, the same variable-wavelength LED may be controlled to emit all of the selected primary emission wavelengths, by supplying different driving subfields to the LED in sequential subframes of a display frame. In this way, the same variable-wavelength LED may be a pixel that emits all primaries one after another within the duration of a single display frame.

In the method of the present invention, only two primaries are used in a given display frame.

The method may comprise the step of selecting a set of two primaries (primary emission wavelengths and their associated subfields of driving conditions) from the palette of N available primary emission wavelengths. The output signal then has an output chromaticity and output luminance L_{O} that are the combination of the first and second primary emission wavelengths and their associated luminances. The absolute wavelengths selected for use as the two primaries in a given display frame will depend on the chromaticity to be displayed by the pixel or subpixels.

The method may comprise the step of selecting different pairs of primary emission wavelengths in different display frames. The most suitable primaries may be selected depending on the desired output signal for each display frame.

The relative luminances of the two primary emission wavelengths are set to sum to a standard illuminant point, so that the colour-balance of the display may be controlled.

The two primary emission wavelengths and their driving subfields may preferably be set so that the combined wavelengths and luminances of the primaries are complementary and sum to a standard illuminant white point, such as CIE standard illuminant point D65.

Maintaining the white balance of the output signal may comprise controlling the luminances of the first and second primary emission wavelengths λ_{P1}, λ_{P2}, so that the combined wavelengths and luminances are complementary and sum to a standard illuminant white point.

The standard illuminant point may be CIE standard illuminant point D65.

The method may be a method of driving a display device comprising a variable-wavelength LED using only two primary emission wavelengths.

The method may comprise the step of driving the display device to emit light at a set of two primary emission wavelengths, so that the output signal is a combination of light emitted at the first and second primary emission wavelengths λ_{P1}, λ_{P2}.

The method may comprise the step of selecting the set of two primary wavelengths for each display frame.

The method may comprise the step of selecting different sets of two primary wavelengths for emission in different display frames.

The variable-wavelength LED may be configured to emit only a first primary emission wavelength λ_{P1}, and a second primary wavelength λ_{P2} may be provided by driving a second LED subpixel with a second subfield of driving conditions.

Alternatively, the variable-wavelength LED may be configured to emit two primary emission wavelengths within the emission range of the variable-wavelength LED, and the method may comprise driving the variable-wavelength LED in a field-sequential manner, in which first and second subfields of driving conditions are supplied to the variable-wavelength LED in discrete sequential subframes of a display frame, so that the variable-wavelength LED emits the first primary emission wavelength λ_{P1} and the second primary emission wavelength λ_{P2} in respective subframes.

At least the first primary emission wavelength is emitted by the variable-wavelength LED. The one or more other primary emission wavelengths may be emitted by the same variable-wavelength LED, a separate variable-wavelength LED subpixel, or a standard single-wavelength LED subpixel.

In a preferred embodiment, the method is a field-sequential driving method for driving a display device comprising a variable-wavelength LED pixel, comprising the steps of:
driving the variable-wavelength LED pixel to emit light at two primary emission wavelengths in response to respective subfields of driving conditions in sequential subframes of the display frame,
in which the wavelengths of the two primary emission wavelengths are variable between display frames, the two primary emission wavelengths being variable within an emission wavelength range of the variable-wavelength LED, and wherein the wavelengths of the two primary emission wavelengths in any given display frame are complementary such that the two primary emission wavelengths and their luminances in the given display frame sum to a standard illuminant point.

The standard illuminant point is preferably a white point.

The standard illuminant point may be CIE standard illuminant point D65.

The method may comprise the step of controlling the duration of a duty cycle during which the variable-wavelength LED is illuminated in a respective subframe, to control the luminance of the respective primary emission wavelength emitted during that subframe.

The method may comprise the step of increasing the duty cycle of a driving subfield to increase the luminance of the respective primary emission wavelength emitted during that subframe.

The method may comprise the step of decreasing the duty cycle of a driving subfield to decrease the luminance of the respective primary emission wavelength emitted during that subframe.

The pair of selected primary emission wavelengths may comprise a longer primary wavelength and a shorter primary wavelength. The method may comprise the step of using a first luminance L₁ of the longer primary wavelength at a first duty cycle as a reference luminance, and setting a second duty cycle of the shorter primary wavelength to a shorter duration than the first duty cycle so that a second luminance L₂ of the second primary wavelength fulfils, with the first luminance L₁, a standard-illuminant-point colour-mixing ratio at which the primary emission wavelengths and luminances of the two primary emission wavelengths are complementary and sum to the standard illuminant point.

The method may comprise the step of selecting, for each display frame, the two primary emission wavelengths to be emitted during the display frame.

The method may comprise the step of selecting different pairs of primary emission wavelengths for different display frames.

The method may comprise the step of dividing the display frame into a plurality of subframes, in which the number of subframes is 2 or more.

Each primary emission wavelength is preferably displayed in one or more display subframes during a display frame.

In a given display frame the variable-wavelength LED is preferably driven to emit light at two discrete primary emission wavelengths during discrete subframes.

The method may comprise the step of driving the variable-wavelength LED pixel by applying, during each subframe, one of two subfields of driving conditions to the variable-wavelength LED, the two subfields corresponding to emission of the two primary emission wavelengths.

The variable-wavelength LED is preferably a microLED.

The variable-wavelength LED preferably has an emission wavelength range with a width of between 100 nm and 200 nm, or between 125 nm and 185 nm, or between 150 nm and 175 nm.

The emission wavelength range preferably extends from a lower limit, which is preferably below 500 nm or below 450 nm, to an upper limit, which is preferably above 595 nm or above 630 nm.

The lower limit of the emission wavelength range may preferably between 440 nm and 495 nm, or between 440 nm and 485 nm, preferably between 450 nm and 470 nm.

The upper limit of the emission wavelength range may preferably be between 595 nm and 700 nm, or between 610 nm and 680 nm, preferably between 625 nm and 670 nm.

The variable-wavelength LED may have a FWHM of 50 nm or less, or 40 nm or less, or 30 nm or less, or 20 nm or less.

The method may comprise the step of selecting first and second primary emission wavelengths.

In a preferred embodiment, the variable-wavelength LED is a device pixel, and the method is a field-sequential driving method for driving the variable-wavelength LED pixel to emit two primary emission wavelengths in sequential subframes of a display frame.

The display device may be a field-sequential display, and the driving method may be a field-sequential driving method for driving a display device.

The variable-wavelength LED may be driven using field-sequential control to emit two discrete primary emission wavelengths in respective sequential subframes of a display frame.

The display device preferably comprises an array of variable-wavelength LEDs, each variable-wavelength LED in the array being individually driveable using the method of the present invention.

The display device may be a subpixellated display device in which the variable-wavelength LED forms a subpixel configured to emit the first primary emission wavelength, and in which the device comprises an additional subpixel configured to emit the other primary emission wavelength.

### Method of Calibrating a 2-Primary Display

In a second aspect the invention may provide a method of calibrating a display device comprising a variable-wavelength LED, the variable-wavelength LED being a pixel of the device, or one of a plurality of subpixels of a device pixel. The display device is preferably programmed to operate using a palette of N available primary emission wavelengths λP, wherein each of the N available primaries is a wavelength emittable by the variable-wavelength LED. The pixel or plurality of subpixels may be driveable to emit light at any of the N available primary emission wavelengths λP in response to N respective subfields of driving conditions. The method may comprise the steps of:
selecting a pair of two discrete primary emission wavelengths λP, each primary emission wavelength λP corresponding to a respective subfield of driving conditions;
calculating, for the two selected primary emission wavelengths, the respective luminances which sum to a standard illuminant point; and
controlling the durations of the respective duty cycles of the two subfields driving the two selected primary emission wavelengths so that the primary emission wavelengths λP and luminances of both primary emission wavelength subfields sum to a standard illuminant point.

The method is preferably a method of calibrating a display device to emit a desired output signal using a combination of two primary wavelengths.

The two selected primary emission wavelengths are preferably a complementary pair of wavelengths which sum to a standard illuminant point.

The method may comprise the step of repeating the method for a plurality of pairs of two primary emission wavelengths.

The method of the present invention may be a method of calibrating a field-sequential display device comprising a variable-wavelength LED pixel, the variable-wavelength LED pixel being driveable to emit light at any of the N available emission wavelengths λ_{P} in response to N respective subfields of driving conditions, the device being driveable to emit different primary emission wavelengths in sequential subframes of a display frame,
in which the N primary emission wavelengths are within an emission wavelength range of the variable-wavelength LED,
the method comprising the step of calculating, for the two selected primary emission wavelengths, the respective luminances which sum to a standard illuminant point; and controlling the durations of the respective duty cycles of the two subfields of driving conditions so that the selected primary emission wavelengths λ_{P} and luminances of both selected primary emission wavelength subfields are complementary and sum to a standard illuminant point.

The standard illuminant point is preferably a white point.

The standard illuminant point may be CIE standard illuminant point D65

The method may comprise the step of driving the variable-wavelength LED pixel across the emission wavelength range of the variable-wavelength LED and mapping in a color space the tristimulus coordinates (x, y: chromaticity, and z: luminance) of the variable-wavelength LED across its emission wavelength range.

The tristimulus-coordinates of the variable-wavelength LED may be mapped in a CIE xy diagram color space.

In which the tristimulus-coordinates of the variable-wavelength LED are mapped in perceptually-linear Munsell L*a*b* color space.

The method may comprise the step of calculating a convex hull of the mapped tristimulus coordinates, preferably in perceptually-linear Munsell L*a*b* color space.

The method may comprise the steps of selecting a first primary wavelength for calibration, the first primary wavelength being a wavelength on the tristimulus coordinates of the variable-wavelength LED, and calculating a first component of a straight line which connects the first primary wavelength for calibration to the standard illuminant point at a constant hue angle.

The method may comprise the step of intersecting the mapped color space by extending a second component of the straight line at the same constant hue angle from the standard illuminant point to an intersection with the mapped tristimulus coordinates of the variable-wavelength LED, in which the second intersection with the mapped tristimulus coordinates is a second primary emission wavelength complementary to the first primary emission wavelength.

The method may comprise the step of calculating the required colour-mixing ratio required to arrive at the standard illuminant point using the first and second primary emission wavelengths by calculating a ratio of the relative lengths of the first component and the second component of the straight line.

The standard illuminant point may be a white point, and the straight line is a white point line.

The method of calibration may comprise repeating the calibration steps for a plurality of pairs of primary emission wavelengths from the palette of N available primary emission wavelengths.

The method may comprise the step of calibrating the luminance of the pair of selected primary emission wavelengths by setting the duty cycles for each pair of primary emission wavelengths so that the complementary wavelengths and their respective luminances sum to the standard illuminant point.

The method may comprise the step of calibrating the luminance of the complementary primary emission wavelengths by measuring the emitted luminance as the variable-wavelength LED pixel is driven across its emission wavelength range.

The method may comprise a step of storing the calibrated duty cycles for the pairs of primary emission wavelengths.

The method preferably comprises the steps of programming a display controller with the calibrated duty cycles for the pairs of primary emission wavelengths.

The method may comprise the steps of:
selecting a maximum emission wavelength usable as a primary emission wavelength within the emission wavelength range of the variable-wavelength LED;
measuring a reference luminance of the variable-wavelength LED at the maximum emission wavelength at 100% duty cycle, in which the variable-wavelength LED is driven to emit light at the maximum emission wavelength for 100% of the duration of a subframe; calculating, using the colour-mixing ratio and the measured luminance at the maximum emission wavelength, the required luminance at a primary emission wavelength in order to complement the maximum emission wavelength to arrive at the standard illuminant point; and
calculating a duty cycle for the primary emission wavelength which will result in the required luminance from the variable-wavelength LED at the primary emission wavelength.

The method may comprise the steps of:
measuring a reference luminance of the longer of the two primary emission wavelengths at 100% duty cycle, in which the variable-wavelength LED is driven to emit light at the longer primary emission wavelength for 100% of the duration of a subframe;
calculating, using the colour-mixing ratio and the measured luminance of the longer primary emission wavelength, the required luminance at the shorter primary emission wavelength in order to arrive at the standard illuminant point; and
calculating a duty cycle for the shorter primary emission wavelength which will result in the required luminance from the variable-wavelength LED at the shorter primary emission wavelength.

The second aspect may have any of the features described above in relation to the first aspect of the invention.

### Opto-Electronic Display Device

The methods of the present invention are preferably carried out on an opto-electronic display device comprising:
a driver wafer comprising a driver circuit; and
a pixel matrix formed by an array of variable-wavelength LEDs, each variable-wavelength LED being connected to the driver circuit and configured to receive a tunable driving signal.

Display devices which are driveable and calibratable using the method of the present invention preferably have a display screen which is made up of an array of variable-wavelength LEDs. Each variable-wavelength LED acts as a pixel, so that the array of variable-wavelength LEDs forms a pixel matrix. Each pixel of the display is preferably a variable-wavelength LED which responds to different driving current densities, or different driving voltages, by emitting different peak emission wavelengths.

The driver circuit may be configured to control the power or the current or the voltage of the power supply to each variable-wavelength LED in the pixel matrix. The driver circuit may be configured to provide a pulsed, or CW, or quasi-CW power supply to the variable-wavelength LED device mesas.

Each variable-wavelength LED has an epitaxial structure which preferably comprises an n-doped region, a p-doped region, and a light-emitting region arranged between the n-doped region and the p-doped region.

Each variable-wavelength LED may comprise a porous region of III-nitride material epitaxially connected to the variable-wavelength LED epitaxial structure.

Particularly preferably, each variable-wavelength LED in the pixel matrix has the same device epitaxial structure. As the array of variable-wavelength LEDs may be formed by etching a single epitaxial structure into a plurality of separate LED device mesas, the composition and layer arrangement of each of the device mesas will be the same.

Although the epitaxial layer design of each variable-wavelength LED is the same, different LEDs may optionally have different lateral sizes, such that different variable-wavelength LEDs have light-emitting areas of different sizes.

Preferably each variable-wavelength LED in the pixel matrix is electrically coupled to its own CMOS driver in the driver circuit, such that each pixel (each variable-wavelength LED) is independently driveable by the driver circuit.

The LED epitaxial device structure of the variable-wavelength LEDs comprise a light-emitting region which preferably comprises a multiple quantum well (MQW) containing a plurality of quantum wells (QWs), or quantum dots, quantum wires, or other quantum nanostructures.

An LED comprises an n-doped portion, a p-doped portion, and a light-emitting region located between the n-doped portion and a p-doped portion, the light-emitting region comprising a light-emitting layer which emits light at a peak emission wavelength under electrical bias thereacross.

### Variable-Wavelength LEDs

In a particularly preferred embodiment, each variable-wavelength LED in the display has the same the variable-wavelength LED device epitaxial structure, such that each variable-wavelength LED in the display device is a separate variable-wavelength LED which is configured to emit a variable peak emission wavelength in response to variations in the driving current provided to that LED. By driving the variable-wavelength LED pixels separately through a driver circuit it is thus advantageously possible to tune the emission wavelength of each pixel individually by providing different driving currents to the variable-wavelength LED pixels.

The variable-wavelength LEDs are configured to emit a variable peak emission wavelength in response to variations in the electrical driving signal (variations in the driving current or driving voltage) provided to the LED. The peak emission wavelength of the LED is preferably continuously controllable over an emission wavelength range of at least 40 nm by varying the driving current to the LED. The peak emission wavelength may preferably be variable over an emission wavelength range of at least 50 nm, or at least 60 nm, or at least 70 nm, or at least 80 nm by varying the driving current, preferably over a range of up to 100 nm or 110 nm or 120 nm or 140 nm, or 160 nm, or 180 nm, or 200 nm, or 400 nm, or 450 nm.

The display is preferably connected to a driver circuit which is configured to supply a variable-magnitude driving current or a variable-magnitude driving voltage, to the variable-wavelength LED pixels, to vary the peak emission wavelength of the variable-wavelength LED device mesas.

A variable-wavelength light emitting diode (LED) driveable and calibratable using the methods of the present invention preferably comprises:
an n-doped portion;
a p-doped portion;
a light-emitting region located between the n-doped portion and a p-doped portion, the light-emitting region comprising a light-emitting layer which emits light at a peak emission wavelength under electrical bias thereacross;
wherein the LED is configured to receive a power supply, in which the peak emission wavelength of the LED is continuously controllable over an emission wavelength range by varying, or controlling, the power supply. The peak emission wavelength of the variable-wavelength LED is preferably continuously controllable, or continuously variable, over an emission wavelength range of at least 40 nm by varying, or controlling, the power supply.

As the peak emission wavelength of the variable-wavelength LED is preferably continuously controllable, or continuously variable, over an emission wavelength range the LED can be described as a variable-wavelength LED.

The variable-wavelength emission behaviour of the LED structure is enabled by the fact that the LED structure (the n-doped portion, the light-emitting region and the p-doped portion) are grown over a template containing a porous region. The present inventors have found that the presence of a porous region of III-nitride material in the template structure prior to overgrowth of the LED structure leads to higher quality crystal growth and thus significant benefits including the possibility of varying the emission wavelength of the LED light-emitting region. The mechanism by which the porous region enables the variable wavelength emission of the LED is the subject of ongoing study. Benefits provided to the LED by the porous region include strain relaxation, lattice parameter enlargement, wafer bow reduction, and mechanical and thermal influence during the light-emitting region being grown at high temperatures.

The variable-wavelength LED is configured to receive a supply of power, or a drive current, from a power supply or LED driver. The term “power supply” is used herein to refer to the power, or current, or voltage, supplied to drive an LED during use.

The peak emission wavelength of the LED may preferably be continuously controllable, or continuously variable, over an emission wavelength range by varying, or controlling, the magnitude of a drive current provided to the variable-wavelength LED.

In traditional LED devices, changes to the driving current provided to the LED produces a very small shift in emission wavelengths, but the present inventors have found that the wavelength shift can be broadened and controlled to a greater extent than traditional LED materials. Rather than the few nm emission range of prior art devices, the LED of the present invention is controllable to emit over a far broader emission range, for example a range of at least 40 nm. As the present LED is tunable to emit over a broad wavelength range, it may be referred to as a variable-wavelength LED.

The LED may be a dynamic colour-tunable LED, in which the peak emission wavelength of the LED is tunable by varying the driving conditions provided to the LED by the driving circuit.

The LED is preferably driveable to emit at a single peak emission wavelength in response to a stable power supply, but to emit at different peak emission wavelengths in response to variations in the power supply. Thus the LED may be used to emit a particular colour for a prolonged period, or alternatively the LED may be driven to emit a variety of different wavelengths by providing varying driving conditions.

Preferably, the n-doped portion, the p-doped portion and the light-emitting region all comprise or consist of III-nitride material, preferably GaN, InGaN, AlGaN or AllnGaN

The variable-wavelength LED preferably contains a single epitaxially-grown diode structure containing the n-doped portion, the p-doped portion and the light-emitting region. Thus the variable peak emission wavelengths of the LED are all emitted by the same LED diode structure and composition.

The LED preferably comprises a porous region of III-nitride material. The light-emitting region of the LED is preferably formed over a porous region of III-nitride material. In some embodiments, one of the n-doped portion or the p-doped portion may contain the porous region of III-nitride material. In other embodiments, the n-doped portion; the p-doped portion; and the light-emitting region are provided on a substrate which comprises the porous region of III-nitride material. During epitaxial growth of the LED, the light-emitting region is preferably overgrown after the porous region has been formed.

The present inventors have found that a porous region of III-nitride material enables the same LED to emit at a range of peak emission wavelengths, rather than at one specific wavelength. The peak emission wavelength of the LED may be varied across an emission wavelength range by varying the power supply provided to the LED. The present invention therefore provides a variable-wavelength LED, which may be controlled to emit at any wavelength across a continuous emission wavelength range. By varying the driving conditions provided to the LED by the power supply, the LED is capable of emitting at any wavelength within the emission wavelength range of said LED, and not simply at discrete peak emission wavelengths.

The present inventors have found that the ability of the LED to emit at tuneable wavelengths across a broad emission range may be imparted by either incorporating a porous region of III-nitride semiconductor material into the LED structure, or forming the LED diode structure over a porous region of III-nitride semiconductor material. Benefits provided to the LED by the porous region include strain relaxation, lattice parameter enlargement, wafer bow reduction, and beneficial mechanical and thermal influences during the growth of the light-emitting region at high temperatures.

The light-emitting region of the LED is preferably formed over a porous region of III-nitride material during manufacture, so that the porous region influences the structure and mechanical properties of layers of semiconductor that are epitaxially deposited over the porous region. Layers of semiconductor material that are deposited over the porous region during growth experience benefits such as strain reduction, lattice parameter enlargement, and wafer bow reduction, which are imparted to the LED light-emitting region and affect its structure and its light-emitting behaviour.

Once the LED light-emitting (active) region has been epitaxially grown over the porous region, and the quality of the active region has been enhanced by the influence of the porous region, the beneficial effects of the porous region on the emission properties are permanently imparted to the LED active region. Thus the LED diode structure may be retained on the porous region, in which case the variable-wavelength LED comprises a porous region of III-nitride material, or alternatively, during the processing of LEDs into devices after epitaxial growth, the porous region may be removed from the LED structure.

The width of the emission wavelength range may vary depending on the structure and composition of the LED structure (the n-doped portion, light-emitting region and p-doped portion), and on the structure and porosity of the porous region. The width of the emission wavelength range may also vary depending on the size and shape of the LED (the pixel size and shape).

In preferred embodiments, the peak emission wavelength is controllable over an emission wavelength range of at least 40 nm, or at least 50 nm, or at least 60 nm, or at least 70 nm, or at least 80 nm by varying the power supply. Preferably the peak emission wavelength is controllable over an emission wavelength range of up to 100 nm, or 110 nm, or 120 nm, or 130 nm, or 140 nm, or 150 nm, or 160 nm, or 170 nm, or 180 nm, or 190 nm, or 200 nm, or 400 nm, or 450 nm. The size of the emission wavelength range obtainable by the present LED is thus far greater than the emission ranges achievable with LEDs of the prior art.

The variable-wavelength LED is advantageously controllable to emit at any peak emission wavelength within its emission wavelength range. By varying the characteristics of the power supply and LED pixel size and shape, the variable-wavelength LED may therefore be controlled to emit light at any selected peak emission wavelength within this range.

The emission wavelength of the variable-wavelength LED is preferably continuously variable across its emission wavelength range in response to driving conditions provided by a power source being varied continuously across a range of driving conditions.

The position of the emission wavelength range in the electromagnetic spectrum may also vary depending on the design of the variable-wavelength LED structure (the n-doped portion, light-emitting region and p-doped portion). For example the wavelengths contained in the emission wavelength range may depend on the number and composition of light emitting layers in the variable-wavelength LED. A large variety of LED active regions are known in the art for emitting at different wavelengths in the visible spectrum, so by light-emitting region forming the LEDs of the present invention with different light-emitting regions, emission wavelength ranges covering different portions of the spectrum may be obtained.

The variable-wavelength LED emission wavelength range may be between 400 nm and 850 nm, or between 400 nm and 800 nm, or between 400 nm and 690 nm, or between 400 nm and 675 nm. The emission wavelength range may be a sub-range within the range of 400 nm to 750 nm. The emission wavelength range may be tuned to cover any part of this range by selecting different LED active regions and controlling the size and shape of the LED pixels.

Preferably the emission wavelength range of the variable-wavelength LED extends from a lower end below 410 nm, or 430 nm, or 450 nm, or 470 nm, or 500 nm, or 520 nm, or 540 nm, or 560 nm, to an upper end above 570 nm, or 580 nm, or 600 nm, or 610 nm, or 630 nm, or 650 nm, or 675 nm. The first and second ends of the emission wavelength range may be tuned depending on the selection of LED structure and LED shape and size, as described above.

For example in preferred embodiments the lower end of the emission wavelength may be between 400 nm and 450 nm (violet) or between 450 nm and 500 nm (blue) or between 500 nm and 570 nm (green), and the upper end of the emission wavelength may be between 570 nm and 590 nm (yellow), or between 590 nm and 610 nm (orange), or between 610 and 700 nm (red).

In a preferred embodiment, the variable-wavelength LED emission wavelength range may extend from a lower end that is below 500 nm to a higher end that is above 610 nm, so that the peak emission wavelength of the LED may be varied to emit at any wavelength from blue (below 500 nm) to red (above 610 nm) by varying the power supply. Providing a single LED design that can be controlled to emit at blue wavelengths (450-500 nm), green (500-570 nm) and also at yellow (570-590 nm), orange (590-610 nm) and red (610-760 nm) is highly advantageous, and could provide significant advantages for LED displays.

In other preferred embodiments, the variable-wavelength LED emission wavelength range may extend between 520 nm and 660 nm, or between 550 nm and 650 nm, by varying the power supply to the LED.

In a particularly preferred embodiment, the peak emission wavelength is controllable between 540 nm and 680 nm, or between 560 nm and 675 nm, by varying the power supply. Thus, the same LED may be controllable to emit at a peak emission wavelength anywhere between 540 nm in the green and 680 nm in the red. Green and red LEDs have historically been more difficult to manufacture than shorter wavelength blue LEDs due to issues such as the difficulty of incorporating the required indium content into the light-emitting region. Providing a single LED design that can be controlled to emit at green wavelengths (500-570 nm) and also at yellow (570-590 nm), orange (590-610 nm) and red (610-760 nm) is therefore highly advantageous, and could provide significant advantages for LED displays.

In another preferred embodiment, the peak emission wavelength is controllable between 520 nm and 675 nm, or between 550 nm and 650 nm, by varying the power supply.

Although the variable-wavelength LED can emit across a continuous emission wavelength range, in some embodiments it may be desirable to control the LED to function in a plurality of discrete emission modes, for example in response to a power supply having a plurality of driving modes. For example by driving the LED in a plurality of different modes corresponding to discrete emission colours, a simplified colour display may be provided, in which discrete emission colours are mixed in known methods to give a desired visual effect.

The variable-wavelength LED is preferably controllable to emit at least two discrete peak emission wavelengths by varying the driving conditions provided by the power supply between two discrete driving conditions (such as two discrete magnitudes of drive current). The LED may be controllable to emit at a first peak emission wavelength in response to a first driving condition provided by the power supply (which may be a drive current having a first magnitude), at a second peak emission wavelength in response to a second driving condition provided by the power supply (which may be a drive current having a second magnitude different from the first magnitude).

The variable-wavelength LED is preferably controllable to emit at least three discrete peak emission wavelengths by varying the driving conditions provided by the power supply. The peak emission wavelength of the variable-wavelength LED may thus be variable over at least three “colours” in the EM spectrum.

The variable-wavelength LED may be controllable to emit at a first peak emission wavelength in response to a first driving condition provided by the power supply, at a second peak emission wavelength in response to a second driving condition provided by the power supply, and at a third peak emission wavelength in response to a third driving condition provided by the power supply.

The variable-wavelength LED may preferably be controllable to emit a blue peak emission wavelength in response to a first driving condition provided by the power supply, to emit a green peak emission wavelength in response to a second driving condition provided by the power supply, and to emit a red peak emission wavelength in response to a third driving condition provided by the power supply.

The variable-wavelength LED may be controllable to emit a first peak emission wavelength in the range 400-500 nm in response to a first driving condition provided by the power supply, to emit a second peak emission wavelength in the range 500-550 nm in response to a second driving condition provided by the power supply, and to emit a third peak emission wavelength greater than 600 nm in response to a third driving condition provided by the power supply.

Preferably, the variable-wavelength LED is controllable to emit a first peak emission wavelength in the range 430-460 nm in response to a first driving condition provided by the power supply, to emit a second peak emission wavelength in the range 510-560 nm in response to a second driving condition provided by the power supply, and to emit a third peak emission wavelength in the range 600-660 nm in response to a third driving condition provided by the power supply.

The first, second and third driving conditions may be first, second and third current densities, or the first, second and third driving conditions may be first, second and third power densities.

The morphology of quantum wells (QWs) in the active light-emitting region may be varied. For example the light-emitting region may contain uniform QWs with well-defined interfaces or fragmented QWs with less well-defined interfaces, fragmentation, or QW well width/composition fluctuation or quantum dots like localisation centres. This control of QW morphology can determine the range of the variable emission wavelength to be controlled and manipulated.

The light-emitting region preferably comprises a plurality of quantum wells (QWs). The quantum wells may be continuous. The quantum wells may be fragmented, or discontinuous.

The variable-wavelength LED may comprise a current constraining layer, or a current limiting layer, which is a dielectric layer configured to confine the lateral area of the LED through which current is conducted. The use of a current constraining layer may advantageously allow further control of the current density, in order to better control the peak emission wavelength of the LED.

The current constraining layer may advantageously enable the manipulation of the power density provided to the variable-wavelength LED, in order to control the peak emission wavelength.

The current constraining layer is preferably a layer of dielectric material. For example, the current constraining layer may be any dielectric, for example SiO₂, SiN or SiNx.

The current constraining layer may be positioned in a variety of positions in the variable-wavelength LED, as long as it confines the lateral area of the LED through which current is conducted. The current constraining layer may be positioned in the LED between an electrical n-contact and an electrical p-contact.

The current constraining layer may be positioned adjacent to either the n-doped portion or the p-doped portion of the LED. For example the current constraining layer may be positioned between the n-doped portion and the light-emitting region. Alternatively the current constraining layer may be positioned between the light-emitting region and the p-doped portion. The current constraining layer may be positioned between an electrical contact and the LED structure (n-doped portion, p-doped portion and light-emitting region).

The current constraining layer preferably comprises an aperture extending through the current constraining layer, or one or more apertures extending through the current constraining layer. The aperture may preferably be positioned in the centre of the current constraining layer. For example the current constraining layer may comprise a circular opening in the centre of the LED structure.

The variable-wavelength LED may be configured so that an electrical contact is in contact with the LED structure via the aperture in the current constraining layer, so that the area of the aperture defines a contact area over which the contact and the LED structure are touching.

The lateral dimensions of the or each aperture is preferably much smaller than the lateral dimensions of the LED. By providing an aperture through the dielectric current constraining layer, high local current density may be achieved, which may advantageously enable improved control of the power through the LED.

For example the lateral width (or diameter) of the aperture may be equal to or less than 50% of the lateral width of the LED structure (the LED mesa). The width of the aperture may be equal to or less than 45%, or 40%, or 35%, or 30%, or 25%, or 20% of the width of the LED structure.

The relative area of the aperture compared to the overall area of the current constraining layer (the blocked region) may be varied to modify the local current density.

The light emitting region preferably comprises a multiple quantum well (MQW) containing a plurality of quantum wells (QWs), or quantum dots, quantum wires, or other quantum nanostructures.

In some embodiments, the light-emitting region comprises a plurality of quantum wells (QWs), and the quantum wells are continuous.

The present inventors have found that non-uniformities in the light-emitting region have a significant effect in broadening the emission wavelength range across which a light-emitting region can emit light in response to variations in the power supplied to the LED. In the prior art, non-uniformities in the light-emitting region are typically considered problematic flaws, which are unwanted and should be avoided in any way possible because the goal is typically a high-quality, low-flaw semiconductor wafer. The present inventors have eschewed this prejudice in the art, and found that intentionally creating non-uniformities in the light emitting region may advantageously broaden the emission wavelength range and result in a variable-wavelength LED which can emit over a far broader wavelength range than has ever been possible in the prior art.

In alternative embodiments of the present invention, the light-emitting region is non-uniform, fragmented, or discontinuous. The light-emitting region may be deliberately introduced to achieve the effect of carrier localisation centres in InGaN quantum wells, such as multiple types of QW region with different Indium composition and well width and quantum barriers, non-uniform, or fragmented, or broken, or gappy, or discontinuous quantum wells which would result in fluctuation in the well width, InGaN quantum dots or nanostructures, quantum wells formed on polar, semi-polar or non-polar facets.

In a preferred embodiment, the light-emitting region comprises a plurality of quantum wells (QWs), and the quantum wells are non-uniform, fragmented, or discontinuous.

The plurality of QWs may comprise fluctuations in well-width. For example the well width of the QWs may fluctuate by at least 2%, 5%, 10%, 20%, 25%, or 50%, or 75%. The well width fluctuations can be variations between quantum wells (vertical direction) as well as within one quantum well (lateral direction).

The plurality of QWs may comprise fluctuations in alloy composition. For example the indium composition of the QWs may vary by at least 2%, 5%, 10%, 20%, 25% or 50% or 75% across the light-emitting region.

The inventors have found that fluctuations in well-width and/or alloy composition may induce carrier localisation centres, either in the upper interface or lower interface of the QWs. Any carrier localisation centres would induce the variable wavelength in the variable-wavelength LED of the present invention. The larger the density of those carrier localisation centres, the larger the variable wavelength range can be achieved.

The variable-wavelength LED may comprise a v-shaped pit which extends, or propagates, through the light emitting active region. Preferably the LED comprises a plurality of v-shaped pits which extend through the light-emitting region.

Preferably the variable-wavelength LED may comprise a density of v-shaped pits (measured looking down onto the LED structure from above) of at least 1×10⁷/cm², for example at least 5×10⁷/cm² or at least 1×10⁸/cm², for example a density of v-shaped pits of 1×10⁷/cm² to 5×10⁹/cm².

The variable-wavelength LED may comprise a density of v-shaped pits of less than 5×10⁹/cm², for example a density of v-shaped pits of less than 1×10⁹/cm² or less than 5×10⁸/cm².

V-shaped pits are a phenomenon known in the art of epitaxial semiconductor growth, and methods of growing v-shaped pits in semiconductor structures are known in the art. For example, v-shaped pits and their growth are described in the prior art in The effect of nanometre-scale V-pits on electronic and optical properties and efficiency droop of GaN-based green light-emitting Diodes; Zhou et al; Scientific Reports|(2018) 8:11053|DOI: 10.1038/s41598-018-29440-4.

These v-shaped pits are v-shaped when viewed in cross-section, but in reality form as conical or funnel-shaped voids in semiconductor structures that are grown from the bottom up using conventional epitaxial growth methods. While the cross-section of the pits is v-shaped, the pits are typically hexagonal when viewed from above. The point of the v-shaped pits are always directed downwards towards earlier-deposited layers of semiconductor structure, as the pits widen as subsequent layers of epitaxial growth are deposited on top of the structure.

Although v-shaped pits are known in the art, they are typically considered a problematic flaw in semiconductor structures, which are unwanted because the goal is typically a high-quality, low-flaw semiconductor wafer.

In the unusual situations where v-shaped pits have been incorporated into semiconductor structures in the past, the v-shaped pits have been used as a screening mechanism to create higher band gap regions which prevent current carriers going down threading dislocations as a leakage path.

In some preferred embodiments of the present invention, however, v-shaped pits are intentionally incorporated into the variable-wavelength LED structure. The v-shaped pits extend far enough down into the semiconductor structure that they terminate in a layer below the active light-emitting region. This means that the v-shaped pits must extend through the thickness of the active light-emitting region.

The present inventors have found that v-shaped pits extending through the light-emitting region of the LED structure may advantageously broaden the emission wavelength range over which a variable-wavelength LED can emit.

As the v-shaped pits extend through the active region of the LED, during epitaxial growth from the bottom up, quantum well (QW) layers that are planar across the rest of the structure are grown on the sloping side walls of the v-shaped pits. The QWs deposited on the pit sidewalls are distorted and stretched around the sides of the pits, so end up being of different thickness and composition compared to the planar QWs across the bulk of the structure.

Around the v-shaped pits, QW layers of semiconductor material are grown as flat planar layers. The active light-emitting region is thus planar around the v-shaped pit. In the location of the v-shaped pits, however, the active layers are distorted and stretched downwards along the sidewalls into the v-shaped pit. This stretching effect changes the thickness of the QWs on the sidewalls of the pit, so that they are different in thickness compared to the planar QW layers formed over the rest of the LED structure.

The inventors have found that v-shaped pits can create local strain relaxation, and MQWs deposited on the sidewall of these v-pits will have different thickness and composition compared to the rest of the MQW, hence the MQW in the region of the v-shaped pits will produce a different emission wavelength.

The quantum wells grown on the side walls of the v-shaped pit are thinner than the bulk planar QWs elsewhere in the structure, which may affect the QW bandgap and allow the QWs in this region to emit at wavelengths different from those emitted by the planar QWs elsewhere in the structure. In addition to this, the QWs on the pit sidewalls may end up having a higher indium (In) content than the surrounding planar QWs, because the sidewalls expose a semipolar facet of the QWs—this facet incorporates more indium during epitaxial growth, so the QWs in the region of the v-shaped pits may be higher in indium than the planar QWs around the pits. Higher indium incorporation typically leads to longer peak emission wavelengths. Both the QW thickness and the indium content affect the emission wavelengths produced by the light-emitting region. The presence of v-shaped pits in the LED structure may thus advantageously modify the composition and thickness of QWs in the light-emitting region in a way that expands the emission wavelength range over which the LED can be driven to emit light.

V-shaped pits typically grow from threading dislocations in the semiconductor structure. The threading dislocations are perpetuated upwards through the structure as additional layers are grown over layers containing a threading dislocation, and at a certain point the dislocation widens into a v-shaped pit. Typically the skilled person aims to keep threading dislocation concentrations low in order to produce a “high quality” low-flaw wafer.

V-shaped pits can alternatively be grown using 3-dimensional epitaxial growth modes. 3D epitaxial deposition techniques are known in the art and are typically used to grow “islands” or “pyramids” of semiconductor material on a template. By controlling deposition of the LED structure using 3D epitaxial deposition techniques, v-shaped pits can be artificially grown in desired locations, with no need for a threading dislocation to be present to “seed” the formation of the v-shaped pit. By using this deposition control, the bottom (nadir) of the pit may be created at a desired location in the structure-both a desired lateral position and a desired height in the structure, for example in a particular layer of the semiconductor structure below the active light-emitting region.

The bottom of the v-shaped pit may be located in the connecting layer of the semiconductor structure. The connecting layer may be positioned between the porous region and the n-doped portion.

The bottom of the v-shaped pit may be located in a pre-strain layer of the semiconductor structure. The pre-strain layer may be positioned above the n-doped portion and below the light-emitting region.

Preferably the variable-wavelength LED comprises a plurality of v-shaped pits which extend through the active light-emitting region.

Preferably the variable-wavelength LED comprises a density of v-shaped pits (measured looking down onto the LED structure from above) of at least 1×10⁷/cm², for example at least 5×10⁷/cm² or at least 1×10⁸/cm². The LED may comprise a density of v-shaped pits of less than 5×10⁹/cm², for example a density of v-shaped pits of less than 1×10⁹/cm² or less than 5×10⁸/cm².

For example the variable-wavelength LED may comprise a density of v-shaped pits of 1×10⁷/cm² to 5×10⁹/cm², or 5×10⁷/cm² to 5×10⁹/cm², or 1×10⁸/cm² to 5×10⁸/cm².

The variable-wavelength LED may comprise more than 0.1 v-shaped pit per square micrometre, or more than 1 v-shaped pits per square micrometre, or more than 2 v-shaped pits per square micrometre.

The concentration of v-shaped pits in the variable-wavelength LED is preferably controlled, as too many v-shaped pits may negatively affect the light emission of the LED by disrupting radiative recombination. For example the LED may comprise fewer than 10 v-shaped pits per square micrometre, or fewer than 8 v-shaped pits per square micrometre, or fewer than 6 v-shaped pits per square micrometre.

In a preferred embodiment the LED structure may comprise no greater than 10\hat{ }9 threading dislocations per square centimetre. Preferably the semiconductor structure below the active light-emitting region (typically a substrate, the porous region and a connecting layer) comprise no more than 10\hat{ }9 threading dislocations per square centimetre. The threading dislocation density is preferably limited to this level so that further epitaxial growth does not create too many v-shaped pits in the light-emitting region.

Both the density and size (the depth) of the v-shaped pits may be controlled. The size of the V-pits can be controlled by the position and the growth conditions of the pre-strain layer and the low-temperature nGaN layer where the pits started.

The morphology of quantum wells (QWs) in the active light-emitting region may be varied. For example the light-emitting region may contain uniform QWs with well-defined interfaces or fragmented QWs with less well-defined interfaces, fragmentation, or QW well width/composition fluctuation or quantum dot like localisation centres. This control of QW morphology can determine the range of the variable emission wavelength to be controlled and manipulated.

The light-emitting region preferably comprises a plurality of quantum wells (QWs). The quantum wells may be continuous. The quantum wells may be fragmented, or discontinuous.

If QWs are continuous and very uniform in thickness and composition, recombination of charge carriers can only happen in regular well defined ways. On the other hand, if QWs are fragmented or discontinuous, this creates lots of nanostructures, which in turn creates different band gaps that result in emission of different colours.

The light-emitting region, and/or the LED, may have lateral dimensions (width and length) of greater than 100 μm and less than 300 μm. In this case, the LED may be termed a “mini-LED”. In preferred embodiments, the mini-LED may be square or circular or square with circular corners and have dimensions such as 300 μm×300 μm, 200 μm×200 μm, 100 μm×100 μm.

The light-emitting region, and/or the LED, may alternatively have lateral dimensions (width and length) of less than 100 μm. In this case, the LED may be termed a “micro-LED”. The micro-LED may preferably have lateral dimensions of less than 80 μm, or 70 μm, or 60 μm, or 50 μm or 30 μm, or 25 μm, or 20 μm, or 15 μm or 10 μm, or 5 μm or 3 μm or 2 μm.

In preferred embodiments, the micro-LED may be square or circular or square with circular corners and have dimensions such as 75 μm×75 μm, 50 μm×50 μm, 40 μm×40 μm, 30 μm×30 μm, 25 μm×25 μm, 20 μm×20 μm or 10 μm×10 μm, or 5 μm×5 μm, or 2 μm×2 μm, or 1 μm×1 μm, or 500 nm×500 nm or smaller.

The light-emitting region, and/or the LED, may alternatively have lateral dimensions (width and length) of less than 1 μm. In this case, the LED may be termed a “nano-LED”. The nano-LED may preferably have lateral dimensions of less than or 500 nm, or 200 nm, or 100 nm, or 50 nm.

The LEDs may be circular, triangle, rectangular, square, oval, diamond, hexagonal, pentagonal, and any combination of these shapes. In the case of irregular-shapes of pixel design, at least one dimension should fall within the dimensions defined above in order for the LEDs to be classed as mini- or micro-LEDs. For example the width or diameter of the LEDs are preferably less than 100 μm so that the LEDs are classed as micro-LEDs.

### Porous Regions

The variable-wavelength LEDs preferably comprise one or more porous regions of III-nitride material.

The n-type region, the light-emitting region and the p-type region (which may be called the LED structure, or LED diode structure) are preferably grown over a semiconductor template which contains the porous region. The semiconductor template may also contain a number of layers of semiconductor material arranged to provide a suitable substrate for the overgrowth of the LED structure.

The porous region may be a porous layer, such that the light emitting diode comprises a porous layer of III-nitride material. Preferably the porous region may be a porous layer that is continuously porous, for example formed from a continuous layer of porous III-nitride material.

The porous region may comprise a plurality of porous layers, and optionally a plurality of non-porous layers. In preferred embodiments of the invention, the porous region is a stack of alternating porous and non-porous layers, with the top surface of the stack defining the top of the porous region, and the bottom surface of the stack defining the bottom of the porous region. The light-emitting region may be formed over a porous region comprising a stack of porous layers of III-nitride material.

Each variable-wavelength LED may comprise its own porous region of III-nitride material, or alternatively a shared porous region may be epitaxially connected to a plurality of the variable-wavelength LEDs.

### Method of Manufacture of Variable-Wavelength LED

A variable-wavelength LED epitaxial device structure may be manufactured by a method comprising the step of growing:
an n-doped portion;
a p-doped portion; and
a light-emitting region located between the n-doped portion and a p-doped portion, the light-emitting region comprising a light-emitting layer which emits light at a peak emission wavelength under electrical bias thereacross.

The method may comprise the step of overgrowing the n-doped portion, the p-doped portion and the light-emitting region over a porous region of III-nitride material.

The method may comprise the step of forming a porous region of III-nitride material in at least one of the n-doped portion or the p-doped portion, and forming the light-emitting region over a porous region of III-nitride material.

The method may optionally comprise the step of removing the porous region from the LED structure (the n-doped portion, the p-doped portion and the light-emitting region) after the n-doped portion, the p-doped portion and the light-emitting region have been formed.

The light-emitting layer may emit light at a peak emission wavelength between 400 and 800 nm, or between 450-800 nm, or between 500 and 800 nm, or between 550 and 800 nm, or between 610 and 800 nm under electrical bias thereacross.

The LED structure, including the n-doped portion, the p-doped portion, and the light-emitting region, may be an LED structure for emitting at a wavelength lower than the peak emission wavelength of the LED, so that the porous region of III-nitride material red-shifts the emission wavelength of the light-emitting region to the peak emission wavelength.

The n-doped portion, the p-doped portion and the light-emitting region are preferably formed from III-nitride semiconductor material.

In a preferred embodiment, the light-emitting region may comprise a light-emitting indium gallium nitride layer for emitting at a peak wavelength of 500 nm-550 nm or 550 nm-600 nm, wherein overgrowth on the porous region of III-nitride material shifts the emission wavelength of the light-emitting region to a peak wavelength between 600 and 750 nm under electrical bias.

The light-emitting region may comprise a light-emitting indium gallium nitride layer for emitting at a peak wavelength of 500-550 nm, or 500-580 nm, or 510 to 570 nm, or 530 nm to 560 nm, or 550 nm to 600 nm. The light-emitting indium gallium nitride layer may be one or more layers known to emit at these wavelengths when grown in conventional LEDs, for example on non-porous GaN substrates. However, the inventors have found that growing conventional yellow or green LED structures over a porous III-nitride layer leads to an LED that emits at a peak wavelength between 600 and 750 nm under electrical bias.

The method may comprise the step of growing a yellow or green LED structure over a porous region of III-nitride material.

In preferred embodiments, the light emitting layer is a light-emitting indium gallium nitride layer. The LED preferably also comprises a region of GaN material. Due to the lattice mismatch between GaN and InGaN, the stress relaxation effect created by the porous region is particularly advantageous.

The method may comprise the step of forming the light emitting active region with carrier localisation centres in the quantum wells (which are preferably InGaN QWs). such as multiple types of QW region with different Indium composition and well width and quantum barriers, non-uniform, or fragmented, or broken, or gappy, or discontinuous quantum wells which would result in fluctuation in the well width, InGaN quantum dots or nanostructures, quantum wells formed on polar, semi-polar or non-polar facets.

The method may comprise the step of forming a plurality of quantum wells (QWs), in which the quantum wells are non-uniform, fragmented, or discontinuous.

The plurality of QWs may comprise fluctuations in indium composition, and/or well width fluctuations.

The method may comprise the step of forming one or more v-shaped pits in the LED structure, so that the v-shaped pit extends through the thickness of the light-emitting region. Preferably the method comprises the step of forming at least 0.1 v-shaped pits per square micrometre, or at least 1 v-shaped pits per square micrometre, or at least 2 v-shaped pits per square micrometre. Preferably the method comprises the step of forming a density of v-shaped pits in the light-emitting region of at least 1×10⁷/cm², for example at least 5×10⁷/cm² or at least 1×10⁸/cm², for example a density of v-shaped pits of 1×10⁷/cm² to 5×10⁹/cm². Preferably the method comprises the step of forming a density of v-shaped pits in the light-emitting region of less than 5×10⁹/cm², for example a density of v-shaped pits of less than 1×10⁹/cm² or less than 5×10⁸/cm².

V-shaped pits are a phenomenon known in the art of epitaxial semiconductor growth, and methods of growing v-shaped pits in semiconductor structures are known in the art. For example, v-shaped pits and their growth are described in the prior art in The effect of nanometre-scale V-pits on electronic and optical properties and efficiency droop of GaN-based green light-emitting Diodes; Zhou et al; Scientific Reports|(2018) 8:11053|DOI: 10.1038/s41598-018-29440-4.

V-shaped pits may be grown in the semiconductor structure so that they terminate in a layer below the active light-emitting region. This means that the v-shaped pits must extend through the thickness of the active light-emitting region.

V-shaped pits may be grown from threading dislocations in the semiconductor structure by controlling the growth conditions during epitaxial deposition of layers above a layer containing a threading dislocation. The threading dislocations are perpetuated upwards through the structure as additional layers are grown over layers containing a threading dislocation, and by controlling growth conditions the dislocation is widened into a v-shaped pit.

V-shaped pits can alternatively be grown using 3-dimensional epitaxial growth modes. 3D epitaxial deposition techniques are known in the art and are typically used to grow “islands” or “pyramids” of semiconductor material on a template. By controlling deposition of the LED structure using 3D epitaxial deposition techniques, v-shaped pits can be artificially grown in desired locations, with no need for a threading dislocation to be present to “seed” the formation of the v-shaped pit. By using this deposition control, the bottom (nadir) of the pit may be created at a desired location in the structure-both a desired lateral position and a desired height in the structure, for example in a particular layer of the semiconductor structure below the active light-emitting region.

The bottom of the v-shaped pit may be located in the connecting layer of the semiconductor structure. The connecting layer may be positioned between the porous region and the n-doped portion.

The bottom of the v-shaped pit may be located in a pre-strain layer of the semiconductor structure. The pre-strain layer may be positioned above the n-doped portion and below the light-emitting region.

Preferably the LED comprises a plurality of v-shaped pits which extend through the active light-emitting region.

Both the density and size (the depth) of the v-shaped pits may be controlled. The size of the V-pits can be controlled by the position and the growth conditions of the pre-strain layer and the low-temperature nGaN layer where the pits started.

Quantum wells (QWs) in the active light-emitting region may be deposited so that the quantum wells are continuous and/or of uniform thickness. Alternatively quantum wells (QWs) in the active light-emitting region may be deposited so that the quantum wells are fragmented, or discontinuous.

### Manufacturing Steps

During manufacture of the array of variable-wavelength LEDs which form the pixel matrix of the device, the n-type region, the light-emitting region and the p-type region (which may be called the LED structure) of the variable-wavelength LEDs are preferably grown over a semiconductor template which contains the porous region. The semiconductor template may also contain a number of layers of semiconductor material arranged to provide a suitable substrate for the overgrowth of the LED structure.

The method may comprise the first step of electrochemically porosifying a layer of III-nitride material, to form the porous region of III-nitride material. This may be achieved using a wafer scale porosification process as set out in international patent applications PCT/GB2017/052895 (published as WO2019/063957) and PCT/GB2019/050213 (published as WO2019/145728).

The method may preferably comprise the step of forming the porous region of III-nitride material by electrochemical porosification through a non-porous layer of III-nitride material, such that the non-porous layer of III-nitride material forms a non-porous intermediate layer. The non-porous intermediate layer may advantageously provide a smooth surface for overgrowth of further layers, such as one or more connecting layers of III-nitride material.

The porous region may be formed by porosifying one or more layers or regions of III-nitride material on a substrate. The substrate may be Silicon, Sapphire, SiC, β-Ga2O3. The crystal orientation of the substrates can be polar, semi-polar or non-polar orientation. The substrate thickness may typically vary between 100 μm and 1500 μm.

The porous region may be a porous layer, such that the method comprises the step of overgrowing, over a porous layer of III-nitride material: an n-doped portion; a p-doped portion; and an LED light-emitting region. Preferably the porous region may be a porous layer that is continuously porous, for example formed from a continuous layer of porous III-nitride material.

The porous region may comprise a plurality of porous layers, and optionally a plurality of non-porous layers. In preferred embodiments of the invention, the porous region is a stack of alternating porous and non-porous layers, with the top surface of the stack defining the top of the porous region, and the bottom surface of the stack defining the bottom of the porous region.

Alternatively the porous region may be a layer of III-nitride material that contains one or more porous regions, for example one or more porous regions in an otherwise non-porous layer of III-nitride material.

In preferred embodiments, the porous region, or porous layer, may have a lateral dimension (width or length) equivalent to that of the substrate wafer on which the porous layer or region is grown. For example, conventional substrate wafer sizes may have a variety of sizes, such as 1 cm², or 2 inch, 4 inch, 6 inch, 8 inch, 12 inch, or 16 inch diameter. By patterning one or more layers and/or depositing regions of different charge carrier concentrations in the same layer, however, smaller porous regions can be formed that do not span the entire substrate. The lateral dimensions of the porous layer or region may therefore vary from around 1/10 of a pixel (for example 0.1 μm), up to the lateral dimensions of the substrate itself.

Prior to the porosification step, a doped region of n-doped III-nitride semiconductor material, preferably containing a layer, or stack of layers, may be deposited on a substrate. The III-nitride layer(s) may contain one or a combination of these elements: Al, Ga, In (ternary of quaternary layer). The thickness of the III-nitride stack is preferably between 10-4000 nm. The III-nitride region may have a doping concentration between 1×10¹⁷ cm⁻³-5×10²⁰ cm⁻³.

Preferably an intermediate layer of undoped III-nitride material is deposited over the doped material before it is porosified. The intermediate layer preferably has a thickness of between 1 nm and 3000 nm, preferably between 5 nm and 2000 nm. As the intermediate layer is undoped, it remains non-porous after the porosification step, which advantageously provides a good surface for epitaxial overgrowth of further layers of semiconductor.

In preferred embodiments, the doped region consists of an alternating stack of doped and undoped layers. In preferred embodiments the stack contains between 5-50 pairs of layers. The thickness of each highly doped layer may vary between 10 nm-200 nm and low-doped or undoped layers may have a thickness of between 5-180 nm.

As is known in the art, electrochemical porosification removes material from n-type doped regions of III-nitride materials, and creates empty pores in the semiconductor material.

In preferred embodiments, the LED structure is formed over a stack of multiple porous layers of III-nitride material. Thus, rather than being a single porous layer of III-nitride material, the porous region may be a stack of layers of III-nitride material in which at least some layers are porous. The stack of porous layers may preferably be a stack of alternating porous and non-porous layers.

The method may preferably comprise the step of depositing one or more connecting layers of III-nitride material on the surface of the intermediate layer of III-nitride material prior to overgrowing the n-doped region, the LED light-emitting region and the p-doped region on the connecting layer.

Alternatively, where there is no non-porous intermediate layer over the porous region, the method may comprise the step of depositing a connecting layer of III-nitride material onto the surface of the porous region of III-nitride material.

The method may comprise the further step of overgrowing the n-doped region, the LED light-emitting region and the p-doped region on the connecting layer.

### BRIEF DESCRIPTION OF THE DRAWINGS

Embodiments of the invention will now be described with reference to the figures, in which:

FIG. 1 illustrates a CIE xy colour gamut and the wavelengths directly emittable by an exemplary variable-wavelength LED usable in the present invention;

FIG. 2 illustrates the colour gamut of FIG. 1, overlaid with a palette of 6 available primaries;

FIG. 3 illustrates the colour gamut of FIG. 2, overlaid with a plurality of colour-mixing lines;

FIG. 4 illustrates the colour gamut of FIG. 1, overlaid with a colour-mixing line through the white-point;

FIG. 5A-5D show simulations of the same image rendered by an sRGB display, and a dynamically-pixel-tuned (DPT) variable-wavelength LED based display being driven with the 2-primary control method of the present invention;

FIGS. 6A and 6B illustrate the colour gamuts displayable using a dynamically-pixel-tuned (DPT) variable-wavelength LED based display being driven with 3-primary control, and with the 2-primary control method of the present invention;

FIGS. 7A-7C illustrate, as 3D colour volumes, the respective colour gamuts displayable using a conventional sRGB display, a variable-wavelength LED display according to the present invention, and Rec. 2020;

FIG. 8 is a series of five EL images of the same MicroLED pixel being driven at different currents in constant wave mode (CW), showing five different colours of emission;

FIG. 9A is an emission wavelength vs current density plot for a 25 μm×25 μm 100×100 variable-wavelength LED pixel array driven in pulsed mode with a 100 μs pulse at 1% duty cycle;

FIG. 9B is an emission wavelength vs current density plot for a 30 μm×30 μm 100×100 variable-wavelength LED pixel array driven in pulsed mode with a 100 μs pulse at 1% duty cycle;

FIG. 10 is a plot of intensity vs wavelength for a single variable-wavelength LED driven at different currents in pulsed driving mode with a 100 μs pulse at 1% duty cycle;

FIGS. 11A-G illustrate alternative embodiments of non-uniform, fragmented or discontinuous light-emitting regions of variable-wavelength LEDs usable in preferred embodiments of the present invention;

FIG. 12A is a TEM image of a cross-section of a conventional non-variable-wavelength LED;

FIG. 12B is a TEM image of the light-emitting region of a variable-wavelength LED comprising v-shaped pits, usable in embodiments of the present invention;

FIG. 12C is a TEM image of the variable-wavelength LED of FIG. 12B, showing a porous region and a light-emitting region comprising a plurality of v-shaped pits, usable in a preferred embodiment of the present invention;

FIG. 13A is a graph of peak emission wavelength vs driving current density for a conventional non-variable wavelength LED;

FIG. 13B is a graph of peak emission wavelength vs driving current density for a variable-wavelength LED according to an embodiment of the present invention;

FIG. 13C is a graph of peak emission wavelength vs driving current density for a variable-wavelength LED according to another embodiment of the present invention;

FIG. 14A is a graph of peak emission wavelength vs driving current density for another variable-wavelength LED usable in embodiments of the present invention;

FIGS. 14B-D are photographs of the variable-wavelength LED of FIG. 14A, with inset emission spectra showing the different peak emission wavelengths at different driving current densities.

As described above, an optoelectronic display device containing a variable-wavelength LED can be operated to display any chromaticity within a displayable colour gamut, by selecting a pair of primary emission wavelengths, and emitting those primary wavelengths in combination to provide a combined output signal with the desired output chromaticity and output luminance.

The size of the colour gamut which is achievable depends on the wavelengths of the primaries selected.

A variable-wavelength LED is used to emit at least one of the two primary emission wavelengths.

In preferred embodiments, the same variable-wavelength pixel is used to emit both of the selected primaries using field-sequential emission. In this case, both of the primary emission wavelengths are selected to be within the emission wavelength range of the variable-wavelength LED.

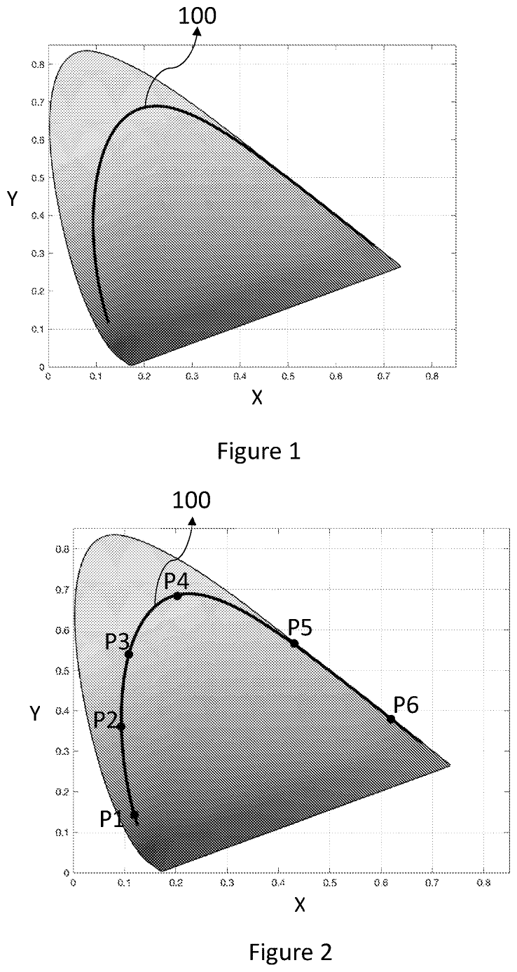

FIG. 1 illustrates a CIE xy color space plot, on which the wavelengths emittable by a variable-wavelength LED are indicated as a continuous black line 100. By varying the driving conditions, such as the magnitude of the driving current or the driving voltage, provided to the LED, the wavelength of light which is directly emitted by the LED may be tuned to any wavelength along line 100.

FIG. 2 is a CIE xy color space plot 200 which illustrates the same emission line 101 as shown in FIG. 1, overlaid with 6 points representing “primaries” P1, P2, P3, P4, P5, P6. These six primaries are specific emission wavelengths which have been selected from the continuous line of emittable-wavelengths 100. The six respective driving conditions required to be supplied to the variable-wavelength LED to result in these six emission wavelengths can be easily found, and those six driving conditions can be programmed into a display device. During operation, those six driving conditions can be supplied to the variable-wavelength LED, leading to the LED emitting light at any one of the six primary wavelengths. The space bounded by the six primaries is the colour gamut of colours which are displayable using the variable-wavelength LED and these six primary wavelengths.

By driving the variable-wavelength LED using field-sequential driving, different driving conditions can be supplied to the LED during discrete subframe time periods. Thus during a first subframe time period, a first driving condition can be supplied to the LED so that the LED emits light at primary wavelength P1. During a subsequent subframe time period, a different driving condition can be supplied to the LED so that the LED emits light at a different primary wavelength (one of P2-α6). In a preferred embodiment, each display frame contains only two subframes, each of which is assigned to the emission of a different primary. The overall colour which will be observed by an observer viewing the variable-wavelength LED will be a temporal average of the two primary wavelengths emitted during the display frame.

It is possible to divide a display frame into any number of shorter subframes. For example one display frame could be divided into six subframes, so that each of the six primaries could be emitted one after the other within a display frame. However, the present inventors have found that it is desirable to use only two of the available primaries during a given display frame, as doing this simplifies colour mixing and reduces the power that is consumed in switching between driving conditions. In order to render a given target colour, two primary wavelengths are selected from the available palette of 6 primaries P1-P6, and the two selected primaries are then mixed proportionally to give a temporal average which appears to an observer to be the target colour.

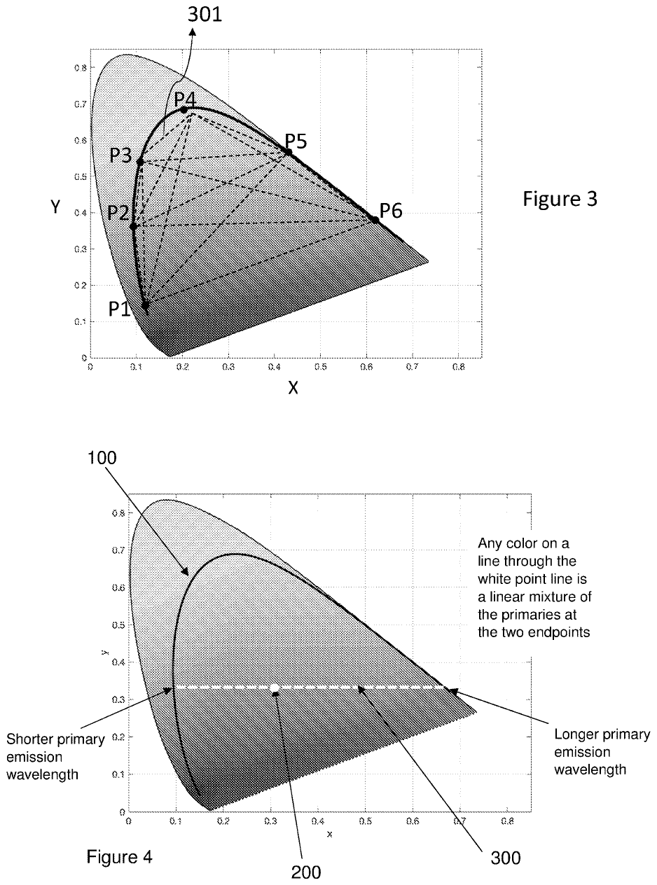

As illustrated in FIG. 3, the palette of 6 available primaries P1-P6 can be divided into a plurality of different pairs. Each pair of primaries can then be linearly mixed with one another to display any colour along the straight lines 301 between the two primary wavelengths.

As is also evident from FIG. 3, however, using a limited set of primaries (N=6 for example) means that not all colours inside the colour gamut are positioned on a linear mixing line 301 between a pair of primaries. Thus with such a small palette of available primaries, not all of the colours in the gamut can be formed from only a pair of primaries.

FIG. 4 illustrates the emission wavelength range (indicated by line 100) of one such variable-wavelength LED usable in the present invention, plotted in CIE xy colour space. The wavelengths emittable by a variable-wavelength LED are indicated as a continuous black line 100. By varying the driving conditions, such as the magnitude of the driving current or the driving voltage, provided to the LED, the wavelength of light which is directly emitted by the LED may be tuned to any wavelength along line 100. Any colour on a colour-mixing line 300 through the white point 200 is a linear mixture of the primary wavelengths at the two endpoints.

Any point on the emission wavelength range line 100 may be used as a primary emission wavelength.

Pairs of complementary primary emission wavelengths are positioned on opposite sides of the white point 200. Any point on the colour-mixing line 300 may be displayed by combining the two primary emission wavelengths at the ends of colour-mixing line 300, in required barycentric-weight proportions. As the colour-mixing line 300 passes through the white point, the two primary emission wavelengths at the intersection between colour-mixing line 300 and emission wavelength range line 100 are a pair of complementary primary emission wavelengths which are combinable to display white light.

CIE xy is a misleading way of illustrating color gamut, because it does not show intensity. CIE xy is not a perceptual space—the relative areas on this chart have no correlation to quality—and green is over-represented. For this reason, it is preferable to work with reference to a 3D color volume in a perceptual color space (Munsell L*a*b*).

Even though we can use all of the wavelengths, we must pick a white-balance condition so that we can set the relative luminances.

White is typically formed from three primaries—in the present invention white is formed with just two primary wavelengths. This is a much more complicated problem, because for every wavelength, it is necessary to find its complement such that the sum is (for example) D65 white.

We build the convex hull of the tristimulus coordinates traced by the LED as it is driven through its wavelength range. The two components which sum to D65, and their respective luminances, are found by intersecting the convex hull at a hue angle corresponding to the first component.

Table 1 illustrates experimental data obtained for a variable-wavelength LED usable in the present invention. Table 1 shows measured conditions from 0.26″ array at 1% APL, in which Wavelength is in units of nm, and L is luminance.

TABLE 1

| Wavelength | FWHM / nm | L / cd/m\hat{ }2 |
|---|---|---|
| 466 | 50 | 1,000,473 |
| 482 | 50 | 880,927 |
| 515 | 50 | 964,512 |
| 517 | 50 | 725,799 |
| 529 | 50 | 429,071 |
| 533 | 50 | 299,851 |
| 545 | 50 | 113,520 |
| 578 | 50 | 12,082 |
| 595 | 50 | 3,264 |
| 616 | 50 | 596 |
| 639 | 50 | 68 |

This shows that the variable-wavelength LEDs emit longer wavelengths at much lower luminances than shorter wavelengths. The low brightness of longer-wavelength primaries can become a limiting factor when high display brightness is desired.

When driving a display comprising a variable-wavelength LED, even though the LED can be driven to emit all of these wavelengths, it is necessary to pick a white-balance condition so that the relative luminances can be set.

For example: based on Table 1 it is known that the variable-wavelength LED emits a luminance of approximately 68 cd/m² of red at a wavelength of 639 nm and, by following the above calculations, D65 white can be formed by combining this red with 119 cd/m² cyan at approximately 492 nm. Red at 639 nm and Cyan at 492 nm can therefore be used as a complementary pair of primary emission wavelengths for two-primary control of the variable-wavelength LED.

Combining 68 cd/m² of red at a wavelength of 639 nm and 119 cd/m² cyan at approximately 492 nm results in an output luminance of 187 cd/m².

In order for the output signal formed from a combination of these two primaries to make D65 white, the luminances of the cyan/red primaries must be set in the ratio 1.7 cyan: 1 red

In order to maximise the brightness of the red primary, the duty cycle of the driving signal for the red primary is set to 100% at 639 nm. This results in the red primary emitting 639 nm with a luminance of 68 cd/m².

Since red luminance is limiting, we end up with the luminances shown to the right in Table 2.

The luminances required from the other emission wavelengths in order to meet the required colour-balance ratio with the red primary at 639 nm, are calculated and shown in Table 2. Knowing the required luminances for these primaries, the duty cycle of the driving signals for the cyan primary is computed to meet the white point condition.

The duty cycles for the other wavelengths are a free parameter and are calculated by interpolation.

TABLE 2

| | | | | L / cd/m\hat{ }2 |
|---|---|---|---|---|
| Wavelength | FWHM / nm | L / cd/m\hat{ }2 | Duty cycle | after duty cycle |
| 466 | 50 | 1,000,473 | 0.00% | 31 |
| 482 | 50 | 880,927 | 0.01% | 75 |
| 515 | 50 | 964,512 | 0.01% | 102 |
| 517 | 50 | 725,799 | 0.01% | 102 |
| 529 | 50 | 429,071 | 0.02% | 107 |
| 533 | 50 | 299,851 | 0.04% | 109 |
| 545 | 50 | 113,520 | 0.10% | 118 |
| 578 | 50 | 12,082 | 1.13% | 137 |
| 595 | 50 | 3,264 | 3.19% | 104 |
| 616 | 50 | 596 | 13.59% | 81 |
| 639 | 50 | 68 | 100.00% | 68 |

Now we have wavelengths (i.e. chromaticity coordinates) and luminances for all wavelengths in the set.

This is limited by the brightness at the longest wavelength to be used as a primary emission wavelength, where the duty cycle is 100%.

In certain scenarios, such a low white-balanced brightness is undesirable, so using the method of the present invention, a less saturated, but brighter, wavelength is selected for the red primary emission wavelength. The newly adjusted red primary emission wavelength is lower, but as it is still driven at 100% duty cycle the luminance for the adjusted red primary emission wavelength is now higher.

An example of this is shown in Table 3, in which 595 nm is selected for use as the red primary emission wavelength, and the duty cycle of the red driving conditions are set to 100% duty cycle. The red primary emission wavelength of 595 nm requires a deeper complementary wavelength of roughly 484 nm. The result of this is that now the two primary emission wavelengths of 595 nm and 484 nm emit a combined output luminance of 5,850 cd/m² out of the display at the D65 white point.

The red emission from the display is now less saturated, but the output luminance is greatly increased.

TABLE 3

| | | | | L / cd/m\hat{ }2 |
|---|---|---|---|---|
| Wavelength | FWHM / nm | L / cd/m\hat{ }2 | Duty cycle | after duty cycle |
| 466 | 50 | 1,000,473 | 0.10% | 969 |
| 482 | 50 | 880,927 | 0.27% | 2,348 |
| 515 | 50 | 964,512 | 0.21% | 2,019 |
| 517 | 50 | 725,799 | 0.28% | 2,038 |
| 529 | 50 | 429,071 | 0.51% | 2,206 |
| 533 | 50 | 299,851 | 0.77% | 2,308 |
| 545 | 50 | 113,520 | 2.36% | 2,684 |
| 578 | 50 | 12,082 | 35.30% | 4,265 |
| 595 | 50 | 3,264 | 100.00% | 3,264 |
| 616 | 50 | 596 | 100.00% | 596 |
| 639 | 50 | 68 | 100.00% | 68 |

The converse situation is also possible, in which the wavelength of the longest primary emission wavelength is increased to increase the displayable gamut at the cost of reduced output luminance.

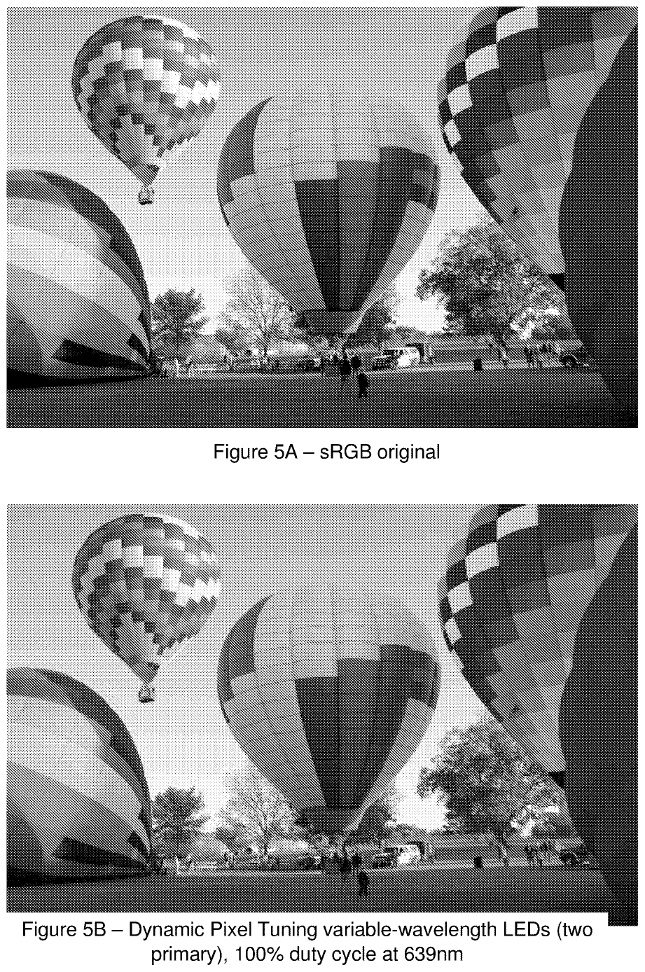

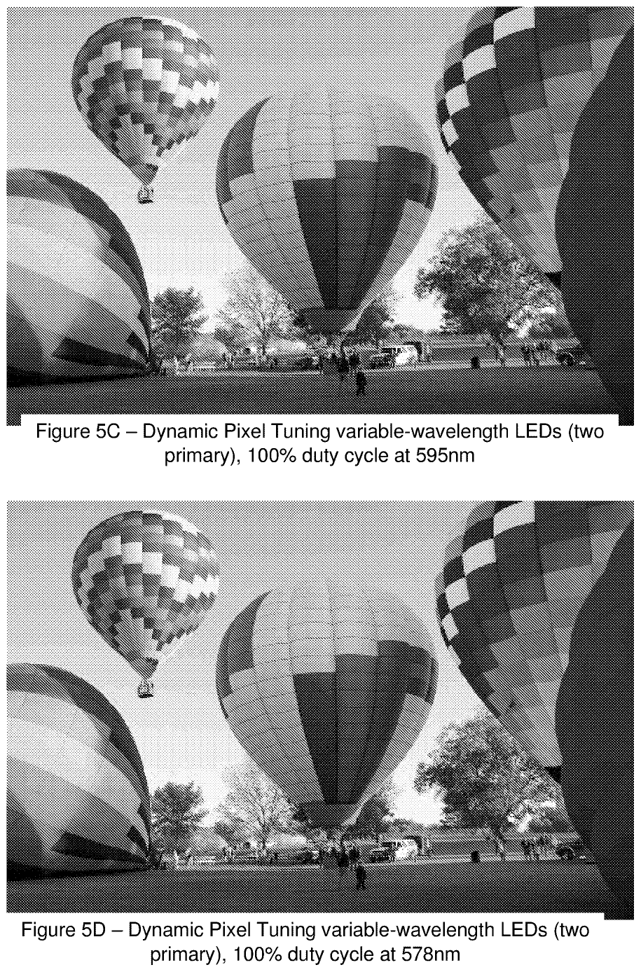

FIG. 5A shows a reference image rendered by an sRGB display.

FIGS. 5B-5D show simulations of the same reference image displayed using a display containing an array of dynamically-pixel-tuned (DPT) variable-wavelength-LED pixels each being driven with the 2-primary control method of the present invention. FIG. 5B shows a simulation of the same reference image displayed using a dynamically-pixel-tuned (DPT) variable-wavelength-LED-based display being driven with the 2-primary control method of the present invention, with the maximum wavelength of the red primary emission wavelength set as 639 nm. FIG. 5C shows a simulation of the same reference image displayed using a dynamically-pixel-tuned (DPT) variable-wavelength-LED-based display being driven with the 2-primary control method of the present invention, with the maximum wavelength of the red primary emission wavelength set as 595 nm. FIG. 5D shows a simulation of the same reference image displayed using a dynamically-pixel-tuned (DPT) variable-wavelength-LED-based display being driven with the 2-primary control method of the present invention, with the maximum wavelength of the red primary emission wavelength set as 578 nm. The comparative image simulations show that setting the maximum red primary emission wavelength to a longer wavelength provides the most saturated colour, while higher brightnesses can be displayed when the red primary is set to 100% duty cycle at a shorter wavelength.

To illustrate image appearance in FIGS. 5B-5D, a gamut mapping algorithm was used to transform sRGB content into the DPT variable-wavelength LED 2-primary gamut. This was carried out in perceptually-linear Munsell L*a*b* color space to ensure a high-quality mapping with preserved hue. There are many specific gamut mapping algorithms—FIGS. 5A-5D demonstrate CLLIN (after Morovic et al.)—and each approach can provide a different tradeoff of contrast and color. An exhaustive approach is outside the scope of this work, and one method has been chosen to provide an illustration.

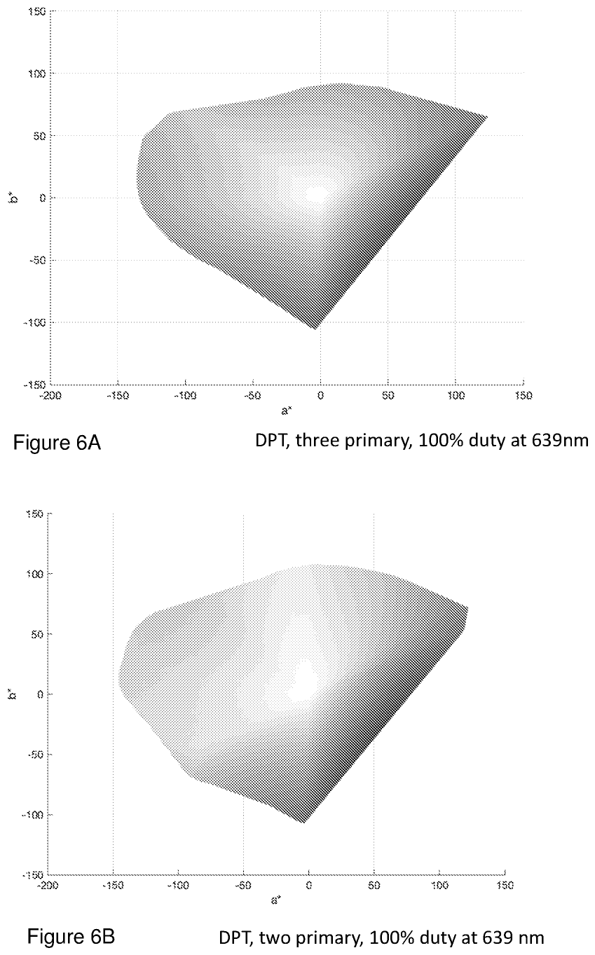

FIG. 6A illustrates in a 2D chroma view the colour gamut displayable using a dynamically-pixel-tuned (DPT) variable-wavelength-LED-based display being driven with 3-primary control. FIG. 6B illustrates in a 2D chroma view the colour gamut displayable using the same dynamically-pixel-tuned (DPT) variable-wavelength-LED-based display with the 2-primary control method of the present invention.

FIGS. 6A and 6B show that the 2-primary method of setting the display compromises the luminance slightly, but the color gamut coverage is much improved. This is because the change in colour balance required for two primaries results in a better yellow and cyan. The red and red/blue axis remain unchanged between 2-primary and 3-primary control modes because the red luminance limitation remains.

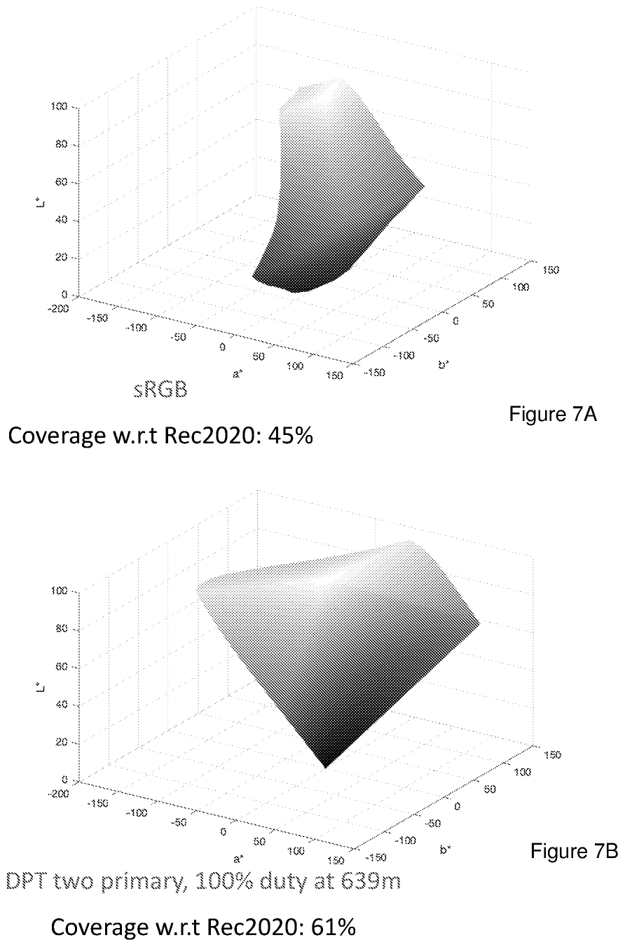

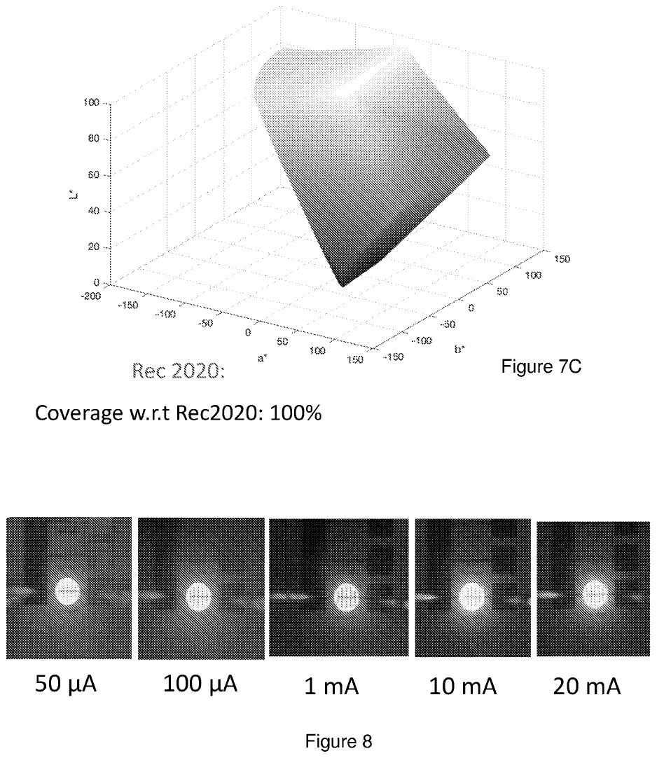

FIG. 7A illustrates, as a 3D colour volume, the colour gamut displayable using a conventional sRGB display. FIG. 7B illustrates the colour gamut displayable using a 2-primary control method for a variable-wavelength LED display according to the present invention. FIG. 7C illustrates the Rec. 2020 (ITU-R Recommendation BT.2020) colour gamut.

It is not straightforward to compare sRGB with the variable-wavelength LED gamut. Since the gamuts of sRGB and DPT variable-wavelength LEDs do not always overlap, rather than express DPT gamut as a percentage of sRGB in CIExy space, it is much better to calculate the intersection of a volume with a reference gamut volume. These computations are performed in the L*a*b* color space.

Variable-wavelength LEDs driven using the dynamic pixel tuning (DPT) two-primary driving method of the present invention with 50 nm FWHM sources and a 100% duty cycle at 639 nm covers 61% of the Rec 2020 space. This is more than is covered by sRGB (45% of Rec 2020 space covered) and the same dynamically-tuned variable-wavelength LEDs with three-primary driving.

### Variable-Wavelength LEDs

Variable-wavelength LEDs driveable in the present invention are described further above and below with reference to FIGS. 8-14E.

In a particularly preferred embodiment of the present invention, the device epitaxial structure from which all of the device mesas are formed is a variable-wavelength LED epitaxial structure. Particularly advantageously, a single variable-wavelength LED epitaxial structure may be grown over a porous region of III-nitride material at wafer-scale to form a monolithic device wafer comprising an array of variable-wavelength LEDs which are formed from the same materials.

An entire wafer-scale device structure may be formed during a single epitaxial growth process, and then the method of the present invention may be used to process the resulting device wafer into an opto-electronic device in which each separate device mesa acts as a separate variable-wavelength LED.

This provides a large number of possibilities for a display device, as the “colour” (the peak emission wavelength) emitted by each LED can be controlled by controlling the driving current density provided to that particular LED mesa in use.

The driving circuit may thus be configured to drive the variable-wavelength LEDs in the device in a variety of ways depending on the desired result:
Each variable-wavelength LED in the device may be dynamically driven by the driving circuit, with each variable-wavelength LED receiving a drive current density the magnitude of which varies in real time during a display frame, so that the same variable-wavelength LED may be controlled to emit a plurality of different wavelengths during a single display frame.
Each variable-wavelength LED may be driven by the driving circuit with a fixed driving current density, so that the variable-wavelength LEDs behave as fixed-wavelength emitters in use. However, the driving circuit may be configured to provide driving current densities of different magnitudes to different variable-wavelength LEDs in the device. Even though the different variable-wavelength LEDs are formed from the same epitaxy and have the same device structure, the different driving current densities control different device mesas to emit different fixed peak emission wavelengths. Thus by providing different fixed drive conditions to different device mesas, a multi-colour display may be provided from a single device epitaxy.
A mixture of these two options may also be provided, with the driving circuit being configured to control some device mesas in the device dynamically, and to control other device mesas as fixed-wavelength emitters by providing a fixed driving current to those mesas.

During manufacturing, the size, shape and position of the variable-wavelength LEDs may be controlled by controlling the size, shape, depth and position of trenches etched into the device wafer.

By forming all of the separate device mesas from a single wafer epitaxy, it is possible to eliminate many of the time-consuming, low-yield and expensive processing steps required for device integration in the prior art.

In preferred embodiments of the present invention, the driving circuit and some or all of the variable-wavelength LEDs are preferably configured to receive a variable-magnitude supply of driving current from the driving circuit, so that the magnitude of the driving current to each variable-wavelength LED is variable. By varying the magnitude of the driving current to a variable-wavelength LED, the peak emission wavelength of that LED can be varied as the display device is used. The driving current provided to each variable-wavelength LED may be individually controllable, so that the peak emission wavelength of each variable-wavelength LED in the display may be controlled and varied individually. Alternatively, the device and the driving circuit may be configured so that the same driving conditions are provided to a group of variable-wavelength LEDs simultaneously, so that all of the variable-wavelength LEDs in that group emit light at the same peak emission wavelength when the driving current is on, and the peak emission wavelength of the entire group can be varied by varying the magnitude of the driving current.

In alternative embodiments, the driving circuit may be configured to provide a fixed-magnitude (i.e. non-variable) driving current, which is either on or off, to some or all of the variable-wavelength LEDs in the display device. When the fixed driving current is on, those variable-wavelength LEDs will behave as conventional LEDs, and emit at a single peak emission wavelength determined by the driving conditions provided to the LEDs. Thus variable-wavelength LEDs which are configured to receive a fixed-magnitude driving current may be used as fixed-emission-wavelength LEDs in the display device.

Preferably the driving circuit is configured to control at least one subpixel of each pixel as a dynamic variable-wavelength LED, the peak emission wavelength of which may be varied within a single display frame.

The driving circuit may be configured to separately control the driving current provided to each of the plurality of LEDs, so that each of the plurality of LEDs is individually driveable. The driving circuit may be configured to provide a plurality of different driving currents to the plurality of LEDs, so that separate LEDs are driveable to emit at different peak emission wavelengths in response to the different driving currents.

Alternatively, the driving circuit may be configured to separately control a groups of two or more LEDs, so that each LED in a group emits at the same peak emission wavelength. The driving circuit may be configured to provide different driving currents to different groups of LEDs, so that separate groups of LEDs are driveable to emit at different peak emission wavelengths in response to the different driving currents.

FIG. 8 is a series of five EL images of the same variable-wavelength MicroLED InGaN pixel being driven at different currents in constant wave mode (CW), showing five different colours of emission. In the left-hand image, the micro-LED emission colour is seen to be red at a driving current of 50 μA. In the second image from the left, the micro-LED emission colour is seen to be red-orange at a driving current of 100 μA. In the third image from the left, the micro-LED emission colour is seen to be orange at a driving current of 1 mA. In the fourth image from the left, the micro-LED emission colour is seen to be yellow-green at a driving current of 10 mA. In the right-hand image, the micro-LED emission colour is seen to be green at a driving current of 20 mA.

By varying the driving current between 50 μA to 20 mA, the same micro-LED is therefore capable of emitting at wavelengths ranging from red to green. The spectral width of this emission wavelength range is on the order of 90 nm (from around 570 nm to around 660 nm). This is a far greater range of emission wavelengths than has ever been achievable with a single LED in the prior art.

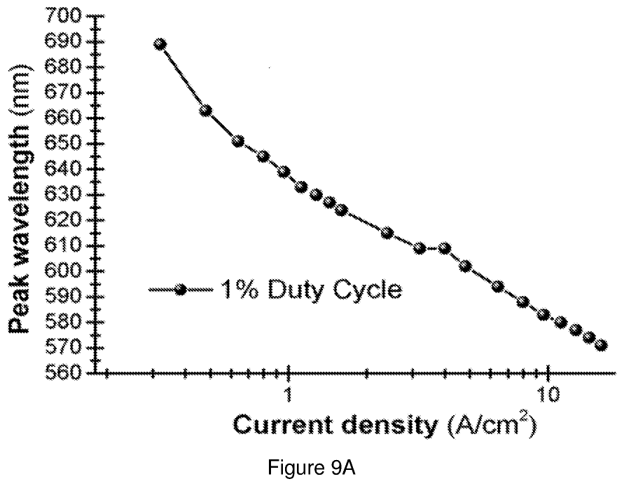

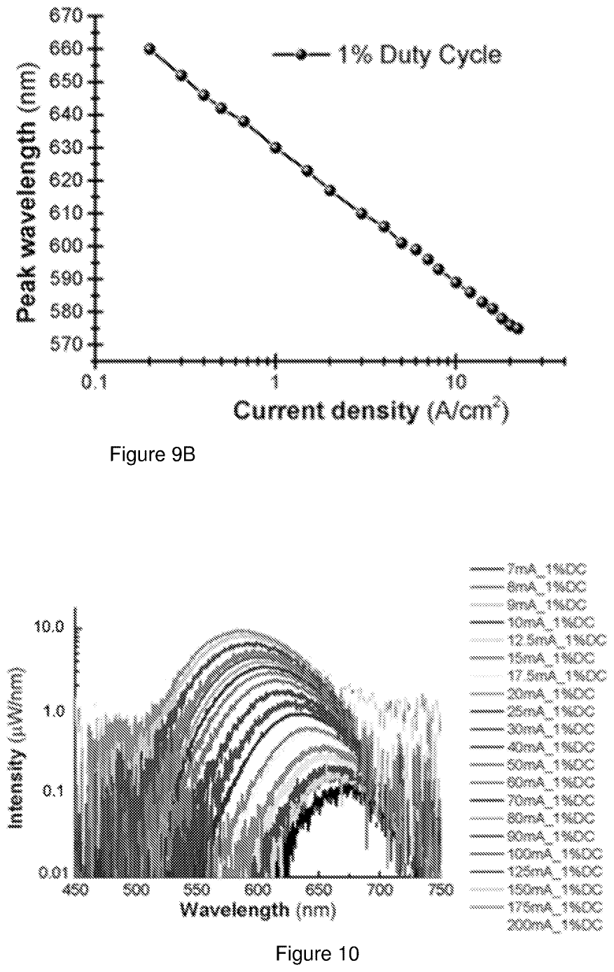

FIG. 9A is an emission wavelength vs current density plot for a 25 μm×25 μm InGaN LED pixel array (100×10 0 array, containing 10,000 pixels) driven in pulsed mode with a 100 μs pulse at 1% duty cycle. FIG. 9B is an emission wavelength vs current density plot for a 30 μm×30 μm InGaN LED pixel array (100×100 array, containing 10,000 pixels) driven in pulsed mode with a 100 μs pulse at 1% duty cycle.

Both of these plots show the controllability of the peak emission wavelength with a pulse driven power supply. In particular, the wavelength is linearly dependent on the current density (plotted on a logarithmic scale). This linearity can equally be manipulated when driving with a pulsed voltage power supply. The variable emission wavelengths of the LED can therefore be controlled with either voltage or current driving schemes in either CW or pulsed mode, all of which are standard ways of display driver IC.

This linear relationship between the driving current density and the resulting emission wavelength is highly advantageous for the purposes of LED display design, as it enables accurate control of the emission wavelengths by varying the current density of the power supply.

FIG. 10 is a plot of intensity vs wavelength for a variable-wavelength InGaN LED driven at different DC currents. The power supply is operated in pulsed driving mode with a 100 us pulse at 1% duty cycle.

FIG. 10 again reflects a gradual, continuous transition of the peak emission wavelength of the LED as the current of the power supply is varied. At a driving current of 200 mA, the peak emission wavelength is around 575 nm, with an intensity of around 10 μW/nm. As the driving current is reduced, however, the peak emission wavelength moves gradually to longer wavelengths, and to lower emission intensities. When the driving current reaches 7 mA, the peak emission wavelength is approximately 675 nm, with an intensity of around 0.1 μW/nm.

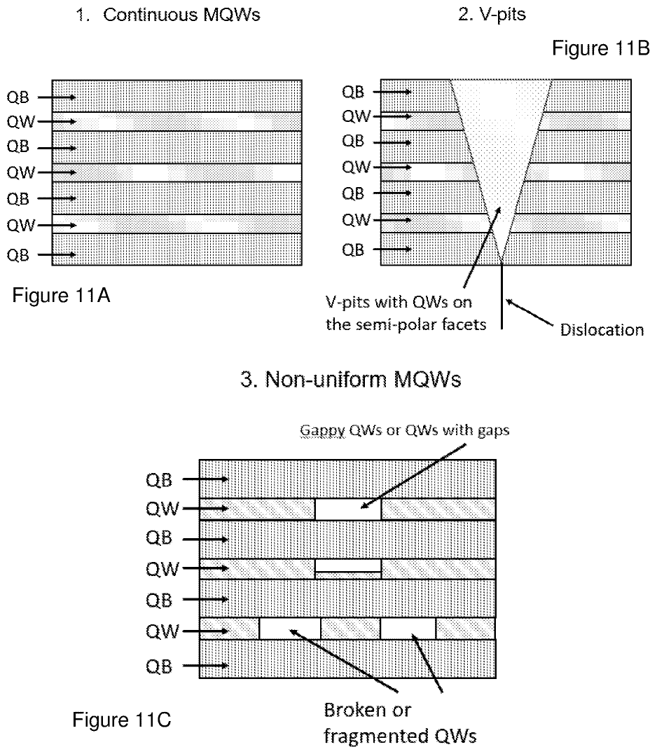

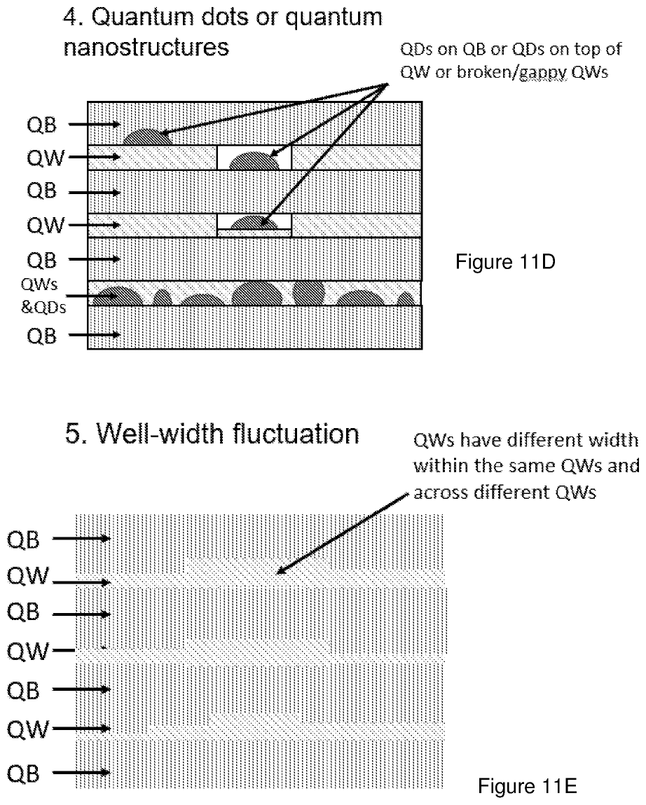

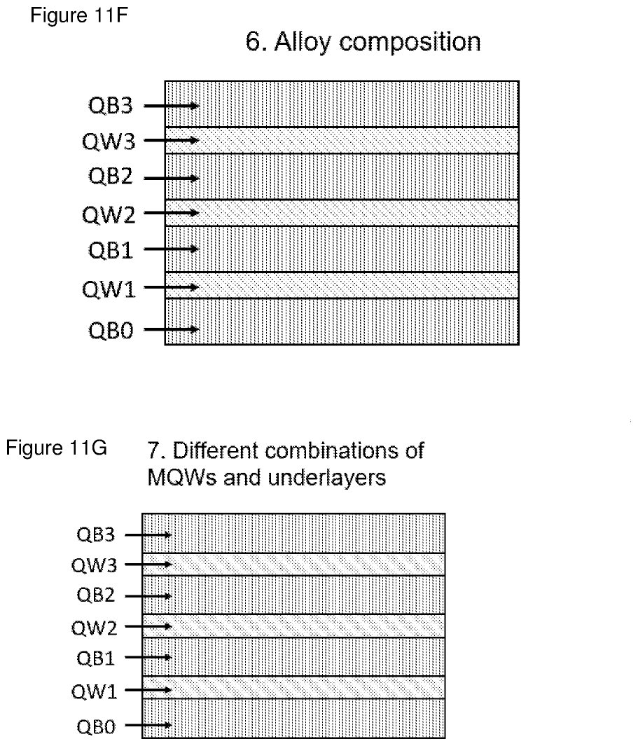

FIGS. 11A-G illustrate alternative embodiments of light-emitting regions of variable-wavelength LEDs which can be used as semiconductor devices in embodiments of the present invention.

### Examples of MQWs:

1. Continuous MQWs
2. V-pits
3. Broken QWs, gappy QWs, fragmented QWs
4. QDs
5. Well-width fluctuation
6. Alloy composition
7. Different combinations of MQWs and underlayers

These structural characteristics can be identified and examined by standard material characterisation techniques, such as cross-sectional transmission electron microscopy (TEM), X-ray diffraction (XRD), Energy Dispersive X-ray Spectroscopy (EDX or EDS), 3D atom probe (3DAP).

FIG. 11A shows a continuous MQW light-emitting region of an LED, in which three identical QWs are provided between four identical quantum barriers (QBs).

FIG. 11B shows the continuous MQW of FIG. 10A, with a V-shaped pit propagating through the light-emitting region. The v-shaped pit terminates in a threading dislocation, and has QWs on its semi-polar facets.

FIG. 11C shows a MQW in which the QW layers comprise discontinuities or gaps in the semiconductor material.

FIG. 11D shows a MQW in which quantum dots (QDs) create non-uniformities in the MQW. QDs may be provided on or in the QB or QW layers, for example in gaps in the QW structure.

FIG. 11E shows a MQW with well-width fluctuation, in which the thicknesses of the QW layers are not uniform across the light-emitting region. The QWs may have different widths from each other, and also varying widths within a single QW.

FIG. 11F shows a MQW with fluctuations in alloy composition in the light-emitting region. The compositions of the QBs and the QWs differ from layer to layer. In particular, the indium In % composition is varying within the same QWs, i.e. in QW2, In % is varying between 10-12% or 10-15%, or 10-25%, or 10-35%.

FIG. 11G shows a MQW containing different combinations of MQWs and underlayers. In % composition is different across different QWs. For example In % in QW1 is 15%, In % in QW2 is 25%, and In % in QW3 is 30%. In embodiments of the present invention, the lower In % QW is preferably positioned at the bottom of the MQW, due to its strain and thermal effect, while the high In % QWs is preferred to be on the top. In a preferred embodiment, for example, QW1 is a blue emitting QW, QW2 is a green emitting QW, QW3 is a red emitting QW.

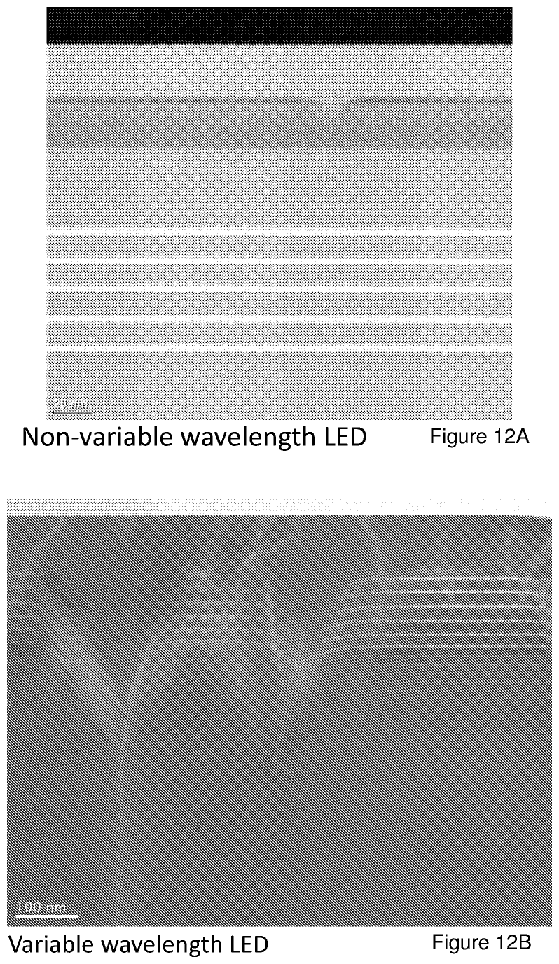

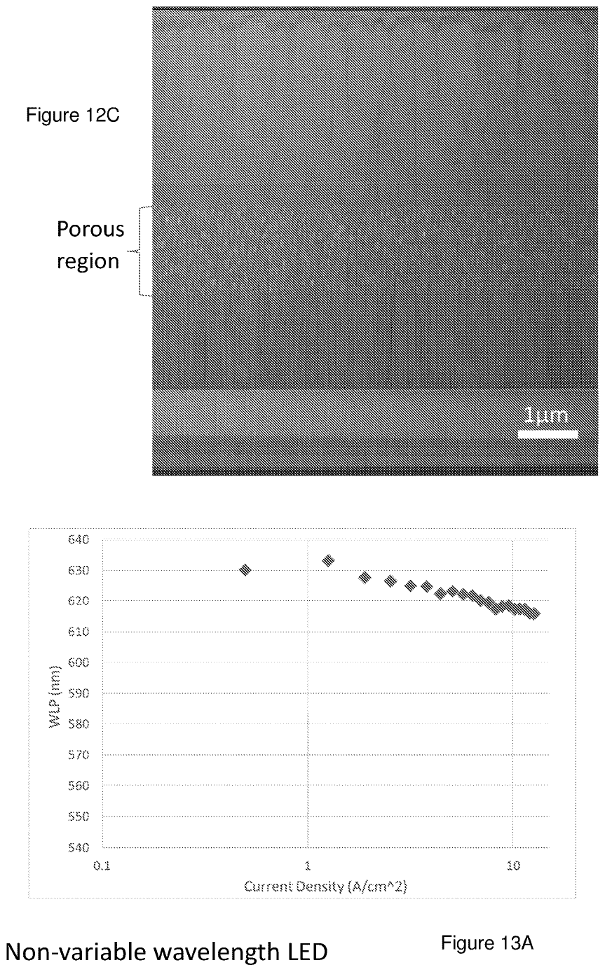

FIG. 12A is a TEM image of a cross-section of a conventional non-variable-wavelength LED. In this non-variable-wavelength LED, the MQWs are uniform and smooth in both upper and lower interface (5 MQWs shown here).

FIGS. 12B and 12C are TEM images a variable-wavelength LED comprising v-shaped pits, usable in an embodiment of the present invention. In this variable-wavelength LED, the MQWs are non-uniform. This non-uniformity can be induced by various methods, one example is v-pits and the semi-polar facets which would incorporate more indium and thinner QWs. Another example is also shown in FIG. 7B, that the MQWs are not uniform, in terms of broken QWs, discontinuous QWs, fragmented QWs, QWs with well-width or In composition fluctuation.

FIG. 12C shows a cross section of the variable-wavelength LED of FIG. 12B, showing a porous region and a light-emitting region comprising a plurality of v-shaped pits, usable in a preferred embodiment of the present invention.

In this structure, the light-emitting region contains multiple emission wavelength regions that are deliberately introduced such as multiple types of QW region with v-shaped pits extending through the light-emitting region.

V-shaped pits (V-pits) are actually hexagonal pits looking from the above, v-shape is when looking at the cross-section. V-pits can be initialize at each site of dislocations under special epitaxy growth conditions during the growth of InGaN, GaN, InGaN/InGaN superlattice, or InGaN/GaN superlattice structures underlying the MQWs, such as low growth temperature (e.g. <1000° C., or <900° C., or <800° C., or <700° C.) and nitrogen ambient.

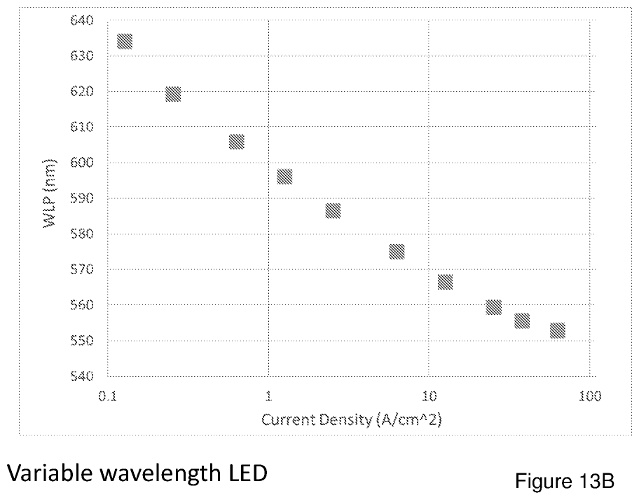

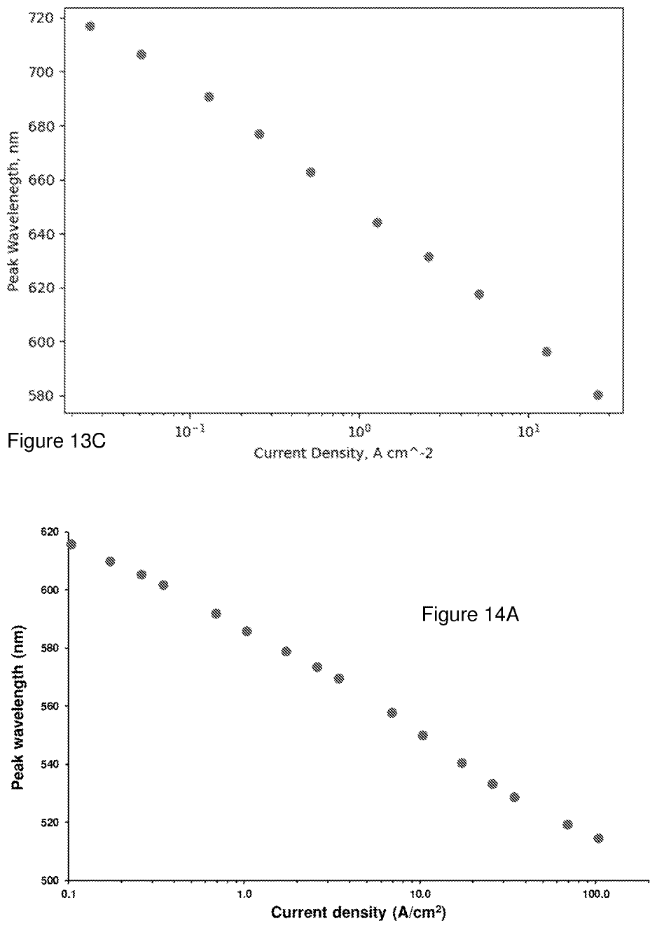

FIG. 13A is a graph of peak emission wavelength vs driving current density for a conventional non-variable wavelength LED. By varying the driving current density applied to the LED, the emission wavelength can be slightly varied, across an emission wavelength range of around 15 nm.

FIG. 13B is a graph of peak emission wavelength vs driving current density for a variable-wavelength LED usable as a first or second semiconductor device in embodiments of the present invention. In the variable-wavelength LED, varying the current density of the driving power supply creates a much larger variation in the peak emission wavelengths (WLP) emitted by the LED. In this embodiment, varying the driving current density between roughly 0.1 and 100 A/cm² varies the peak emission wavelength from around 635 nm to around 550 nm—an emission wavelength range of around 85 nm.

FIG. 13C is a graph of peak emission wavelength vs driving current density for a variable-wavelength LED according to another embodiment of the present invention. In this embodiment, varying the driving current density varies the peak emission wavelength from around 720 nm to around 580 nm—an emission wavelength range of around 140 nm.

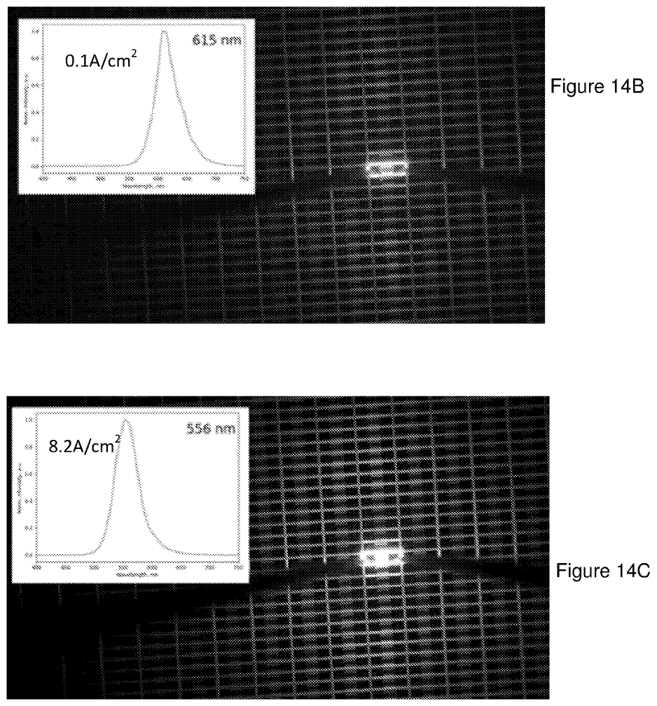

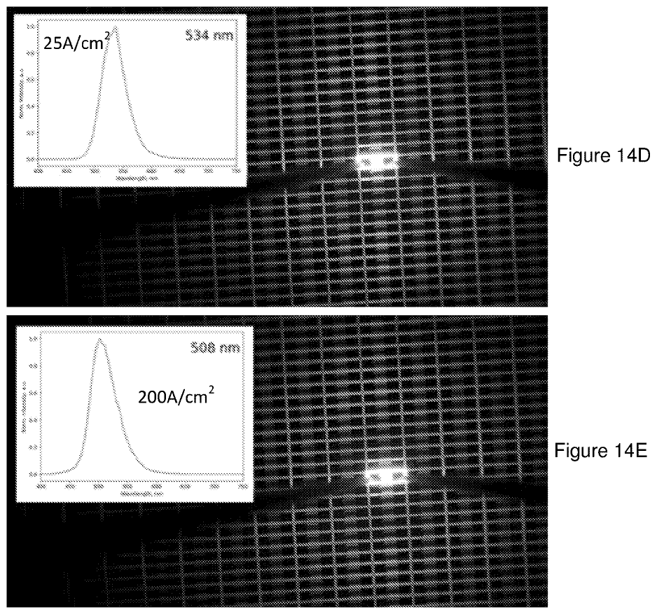

FIG. 14A is a graph of peak emission wavelength vs driving current density for another variable-wavelength LED according to the present invention. In this embodiment, varying the driving current density between roughly 0.1 and 200 A/cm² varies the peak emission wavelength from 615 nm to 508 nm—an emission wavelength range of around 100 nm. The data for this graph only goes to 514.5 nm due to a limitation on the testing capabilities. The current density for 508 nm is therefore estimated. However, the obtainable range of emission wavelengths can be pushed either way significantly.

FIGS. 14B-D are photographs of the variable-wavelength LED of FIG. 14A, showing the same variable-wavelength LED emitting at four different wavelengths across its emission wavelength range. The inset emission spectra show the different peak emission wavelengths at different driving current densities. This shows the same variable-wavelength LED emitting at peak emission wavelengths in the orange (615 nm), yellow (556 nm), green (534 nm) and blue (508 nm) in response to different driving current densities.

### Preferred Aspects

Preferred aspects of the invention are set out in the following numbered clauses:
1. A method of driving a display device comprising a variable-wavelength LED, the variable-wavelength LED being a pixel of the device, or one of a plurality of subpixels of a device pixel, the variable-wavelength LED being driveable to emit light at N emission wavelengths λ in response to N respective subfields of driving conditions,
   the method comprising the steps of:
   driving the pixel or subpixels to emit light at two primary emission wavelengths within a display frame in response to respective subfields of driving conditions, so that the light emitted at the two primary emission wavelengths combines to form an output signal with an output chromaticity and output luminance L_{O};
   in which the wavelengths of the two primary emission wavelengths are varied between display frames, the two primary emission wavelengths being variable within an emission wavelength range of the variable-wavelength LED, and wherein the wavelengths of the two primary emission wavelengths in any given display frame are complementary such that the two primary emission wavelengths in the given display frame sum to a standard illuminant point.
2. The method of clause 1, in which the method is a field-sequential driving method for driving a display device comprising a variable-wavelength LED pixel, comprising the steps of:
   driving the variable-wavelength LED pixel to emit light at two primary emission wavelengths in response to respective subfields of driving conditions in sequential subframes of the display frame,
   in which the wavelengths of the two primary emission wavelengths are varied between display frames, the two primary emission wavelengths being variable within an emission wavelength range of the variable-wavelength LED, and wherein the wavelengths of the two primary emission wavelengths in any given display frame are complementary such that the two primary emission wavelengths and their luminances in the given display frame sum to a standard illuminant point.
3. The method of clause 1 or 2, in which the standard illuminant point is a white point.
4. The method of any preceding clause, in which the standard illuminant point is CIE standard illuminant point D65.
5. The method of any preceding clause, comprising the step of controlling the duration of a duty cycle during which the variable-wavelength LED is illuminated in a respective subframe, to control the luminance of the respective primary emission wavelength emitted during that subframe.
6. The method of any preceding clause, comprising the step of increasing the duty cycle to increase the luminance of the respective primary emission wavelength emitted during that subframe.
7. The method of any preceding clause, comprising the step of decreasing the duty cycle to decrease the luminance of the respective primary emission wavelength emitted during that subframe.
8. The method of any preceding clause, comprising the step of using a first luminance L₁ of the longer primary wavelength at a first duty cycle as a reference luminance, and setting a second duty cycle of the shorter primary wavelength to a shorter duration than the first duty cycle so that a second luminance L₂ of the second primary wavelength fulfils, with the first luminance L₁, a standard-illuminant-point colour-mixing ratio at which the primary emission wavelengths and luminances of the two primary emission wavelengths are complementary and sum to the standard illuminant point.
9. The method of any preceding clause, comprising the step of selecting, for each display frame, the two primary emission wavelengths to be emitted during the display frame.
10. The method of any preceding clause, comprising the step of selecting different pairs of primary emission wavelengths for different display frames, and driving the pixel or subpixel to emit different pairs of primary emission wavelengths in different display frames.
11. The method of any preceding clause, comprising the step of dividing the display frame into a plurality of subframes, in which the number of subframes is 2 or more.
12. The method of any preceding clause, in which each primary emission wavelength is displayed in one or more display subframes during a display frame.
13. The method of any preceding clause, in which in a given display frame the variable-wavelength LED is driven to emit light at two discrete primary emission wavelengths during discrete subframes.
14. The method of any preceding clause, comprising the step of driving the variable-wavelength LED pixel by applying, during each subframe, one of two subfields of driving conditions to the variable-wavelength LED, the two subfields corresponding to emission of the two primary emission wavelengths.
15. The method of any preceding clause, in which the variable-wavelength LED has an emission wavelength range of between 100 nm and 200 nm, or between 125 nm and 185 nm, or between 150 nm and 175 nm.
16. The method of any preceding clause, in which the emission wavelength range extends from a lower limit, which is preferably below 500 nm or below 450 nm, to an upper limit, which is preferably above 595 nm or above 630 nm.
17. The method of clause 16, in which the lower limit of the emission wavelength range is between 440 nm and 495 nm, or between 440 nm and 485 nm, preferably between 450 nm and 470 nm.
18. The method of clause 16 or 17, in which the upper limit of the emission wavelength range is between 595 nm and 700 nm, or between 610 nm and 680 nm, preferably between 625 nm and 670 nm.
19. The method of any preceding clause, in which the variable-wavelength LED has a FWHM of 50 nm or less, or 40 nm or less, or 30 nm or less, or 20 nm or less.
20. A method of calibrating a display device comprising a variable-wavelength LED, the variable-wavelength LED being a pixel of the device, or one of a plurality of subpixels of a device pixel, the pixel or plurality of subpixels being driveable to emit light at N emission wavelengths λ_{P} in response to N respective subfields of driving conditions, the method comprising the steps of:
   selecting two discrete primary emission wavelengths λP, each primary emission wavelength λ_{P} corresponding to a respective subfield of driving conditions;
   calculating, for the two primary emission wavelengths, the complementary wavelengths and respective luminances which sum to a standard illuminant point;
   and controlling the durations of the respective duty cycles of the two subfields driving the two primary emission wavelengths so that the primary emission wavelengths λ_{P} and luminances of both primary emission wavelength subfields are complementary and sum to a standard illuminant point.
21. The method of clause 20, in which the two selected primary emission wavelengths are a complementary pair of wavelengths which sum to a standard illuminant point.
22. The method of clause 20 or 21, comprising the step of repeating the method for a plurality of pairs of two primary emission wavelengths.
23. The method of clause 20, 21 or 22, in which the method is a method of calibrating a field-sequential display device comprising a variable-wavelength LED pixel, the variable-wavelength LED pixel being driveable to emit light at N emission wavelengths λ_{P} in response to N respective subfields of driving conditions in sequential subframes of a display frame,
   in which the wavelengths of the two primary emission wavelengths are variable within an emission wavelength range of the variable-wavelength LED, the method comprising the step of calculating, for the two primary emission wavelengths, the complementary wavelengths and respective luminances which sum to a standard illuminant point;
   and controlling the durations of the respective duty cycles of the two subfields so that the primary emission wavelengths λ_{P} and luminances of both primary emission wavelength subfields are complementary and sum to a standard illuminant point.
24. The method of any of clauses 20 to 23, in which the standard illuminant point is a white point.
25. The method of any of clauses 20 to 24, in which the standard illuminant point is CIE standard illuminant point D65.
26. The method of any of clauses 20 to 25, comprising the step of driving the variable-wavelength LED pixel across the emission wavelength range of the variable-wavelength LED and mapping in a color space the tristimulus coordinates (x, y: chromaticity, and z: luminance) of the variable-wavelength LED across its emission wavelength range.
27. The method of clause 26, in which the tristimulus-coordinates of the variable-wavelength LED are mapped in a CIE xy diagram color space.
28. The method of clause 26, in which the tristimulus-coordinates of the variable-wavelength LED are mapped in perceptually-linear Munsell L*a*b* color space.
29. The method of clause 28, comprising the step of calculating a convex hull of the mapped tristimulus coordinates in perceptually-linear Munsell L*a*b* color space.
30. The method of any of clauses 26 to 29, comprising the steps of selecting a first primary wavelength for calibration, the first primary wavelength being a wavelength on the tristimulus coordinates of the variable-wavelength LED, and calculating a first component of a straight line which connects the first primary wavelength for calibration to the standard illuminant point at a constant hue angle.
31. The method of any of clauses 26 to 30, comprising the step of intersecting the mapped color space by extending a second component of the straight line at the same constant hue angle from the standard illuminant point to an intersection with the mapped tristimulus coordinates of the variable-wavelength LED, in which the second intersection with the mapped tristimulus coordinates is a second primary emission wavelength complementary to the first primary emission wavelength.
32. The method of any of clauses 26 to 31, comprising the step of calculating the required colour-mixing ratio required to arrive at the standard illuminant point using the first and second primary emission wavelengths by calculating a ratio of the relative lengths of the first component and the second component of the straight line.
33. The method of clause 32, in which the standard illuminant point is a white point, and the straight line is a white point line.
34. The method of any of clauses 20 to 33, comprising the step of calibrating the luminance of the two complementary primary emission wavelengths by setting the duty cycles for each pair of primary emission wavelengths so that the complementary wavelengths and their respective luminances sum to the standard illuminant point.
35. The method of any of clauses 20 to 34, comprising the step of calibrating the luminance of the complementary primary emission wavelengths by measuring the emitted luminance as the variable-wavelength LED pixel is driven across its emission wavelength range.
36. The method of any of clauses 20 to 35, comprising the steps of:
   selecting a maximum emission wavelength usable as a primary emission wavelength within the emission wavelength range of the variable-wavelength LED; measuring a reference luminance of the variable-wavelength LED at the maximum emission wavelength at 100% duty cycle, in which the variable-wavelength LED is driven to emit light at the maximum emission wavelength for 100% of the duration of a subframe;
   calculating, using the colour-mixing ratio and the measured luminance at the maximum emission wavelength, the required luminance at a primary emission wavelength in order to complement the maximum emission wavelength to arrive at the standard illuminant point; and
   calculating a duty cycle for the primary emission wavelength which will result in the required luminance from the variable-wavelength LED at the primary emission wavelength.
37. The method of any of clauses 20 to 35, comprising the steps of:
   measuring a reference luminance of the longer of the two primary emission wavelengths at 100% duty cycle, in which the variable-wavelength LED is driven to emit light at the longer primary emission wavelength for 100% of the duration of a subframe;
   calculating, using the colour-mixing ratio and the measured luminance of the longer primary emission wavelength, the required luminance at the shorter primary emission wavelength in order to arrive at the standard illuminant point; and calculating a duty cycle for the shorter primary emission wavelength which will result in the required luminance from the variable-wavelength LED at the shorter primary emission wavelength.

1. A method of driving a display device comprising a variable-wavelength LED, the variable-wavelength LED being a pixel of the device, or one of a plurality of subpixels of a device pixel, the display device being programmed to operate using a palette of N available primary emission wavelengths λ_{P}, wherein each of the N available primaries is a wavelength emittable by the variable-wavelength LED, the variable-wavelength LED being driveable to emit light at any of the N available primary emission wavelengths λ_{P} in response to N respective subfields of driving conditions,
the method comprising the steps of:
identifying an output signal to be displayed by a pixel, or a subpixel, of the display device during a display frame;
selecting a pair of two of the N available primary emission wavelengths which are combinable to form the output signal;
driving the pixel or subpixel to emit light at the two selected primary emission wavelengths during two subframes within the display frame, so that the light emitted at the two selected primary emission wavelengths during the display frame combines to form the output signal with an output chromaticity and output luminance L_{O}.

2. The method of claim 1, in which the N available primaries define a colour gamut of a plurality of displayable colours, and in which the selected primary emission wavelengths define a displayable area of the colour gamut which is displayable by mixing the selected primary emission wavelengths.

3. The method of claim 1 or 2, in which the display frame consists of two subframes, in which one of the pair of selected primary emission wavelengths is emitted in each subframe of the display frame.

4. The method of claim 1, 2 or 3, in which the two selected primary emission wavelengths are varied between display frames, the two selected primary emission wavelengths being variable within the palette of N available primary emission wavelengths.

5. The method of any preceding claim, wherein the wavelengths of the two selected primary emission wavelengths used in any given display frame are complementary, such that the two primary emission wavelengths in the given display frame are combinable to display a standard illuminant point.

6. The method of any preceding claim, in which the method is a field-sequential driving method for driving a display device comprising a variable-wavelength LED pixel, comprising the steps of:
driving the variable-wavelength LED pixel to emit light at the two selected primary emission wavelengths in response to respective subfields of driving conditions in sequential subframes of the display frame.

7. The method of claim 6, in which the wavelengths of the two selected primary emission wavelengths are varied between display frames, the two primary emission wavelengths being variable within an emission wavelength range of the variable-wavelength LED, and wherein the wavelengths of the two primary emission wavelengths in any given display frame are complementary such that the two selected primary emission wavelengths and their luminances in the given display frame sum to a standard illuminant point.

8. The method of claim 5, 6 or 7, in which the standard illuminant point is a white point.

9. The method of any of claims 5 to 8, in which the standard illuminant point is CIE standard illuminant point D65.

10. The method of any preceding claim, comprising the step of controlling the duration of a duty cycle during which the variable-wavelength LED is illuminated in a respective subframe, to control the luminance of the respective primary emission wavelength emitted during that subframe.

11. The method of any preceding claim, comprising the step of increasing the duty cycle to increase the luminance of the respective primary emission wavelength emitted during that subframe.

12. The method of any preceding claim, comprising the step of decreasing the duty cycle to decrease the luminance of the respective primary emission wavelength emitted during that subframe.

13. The method of any of claims 5 to 12, in which the pair of selected primary emission wavelengths comprise a longer primary wavelength and a shorter primary wavelength, and wherein the method comprises the step of using a first luminance L₁ of the longer primary wavelength at a first duty cycle as a reference luminance, and setting a second duty cycle of the shorter primary wavelength to a shorter duration than the first duty cycle so that a second luminance L₂ of the second primary wavelength fulfils, with the first luminance L₁, a standard-illuminant-point colour-mixing ratio at which the two selected primary emission wavelengths and luminances of the two selected primary emission wavelengths are complementary and sum to the standard illuminant point.

14. The method of any preceding claim, comprising the step of selecting, for each display frame, the two primary emission wavelengths to be emitted during the display frame.

15. The method of any preceding claim, comprising the step of selecting different pairs of primary emission wavelengths for different display frames, and driving the pixel or subpixel to emit different pairs of primary emission wavelengths in different display frames.

16. The method of any preceding claim, comprising the step of dividing the display frame into a plurality of subframes, in which the number of subframes is 2 or more.

17. The method of any preceding claim, in which each primary emission wavelength is displayed in one or more display subframes during a display frame.

18. The method of any preceding claim, in which in a given display frame the variable-wavelength LED is driven to emit light at two discrete primary emission wavelengths during discrete subframes.

19. The method of any preceding claim, comprising the step of driving the variable-wavelength LED pixel by applying, during each subframe, one of two subfields of driving conditions to the variable-wavelength LED, the two subfields corresponding to emission of the two selected primary emission wavelengths.

20. The method of any preceding claim, in which the variable-wavelength LED has an emission wavelength range of between 100 nm and 200 nm, or between 125 nm and 185 nm, or between 150 nm and 175 nm.

21. The method of any preceding claim, in which the emission wavelength range extends from a lower limit, which is preferably below 500 nm or below 450 nm, to an upper limit, which is preferably above 595 nm or above 630 nm.

22. The method of claim 21, in which the lower limit of the emission wavelength range is between 440 nm and 495 nm, or between 440 nm and 485 nm, preferably between 450 nm and 470 nm.

23. The method of claim 21 or 22, in which the upper limit of the emission wavelength range is between 595 nm and 700 nm, or between 610 nm and 680 nm, preferably between 625 nm and 670 nm.

24. The method of any preceding claim, in which the variable-wavelength LED has a FWHM of 50 nm or less, or 40 nm or less, or 30 nm or less, or 20 nm or less.

25. A method of calibrating a display device comprising a variable-wavelength LED, the variable-wavelength LED being a pixel of the device, or one of a plurality of subpixels of a device pixel, the display device being programmed to operate using a palette of N available primary emission wavelengths λP, wherein each of the N available primaries is a wavelength emittable by the variable-wavelength LED, the pixel or plurality of subpixels being driveable to emit light at any of the N available primary emission wavelengths λ_{P} in response to N respective subfields of driving conditions, the method comprising the steps of:
selecting a pair of two discrete primary emission wavelengths λ_{P}, each primary emission wavelength λ_{P} corresponding to a respective subfield of driving conditions;
calculating, for the two selected primary emission wavelengths, the respective luminances which sum to a standard illuminant point;
and controlling the durations of the respective duty cycles of the two subfields driving the two selected primary emission wavelengths so that the selected primary emission wavelengths λ_{P} and luminances of both selected primary emission wavelength subfields are complementary and sum to a standard illuminant point.

26. The method of claim 25, in which the two selected primary emission wavelengths are a complementary pair of wavelengths which sum to a standard illuminant point.

27. The method of claim 25 or 26, comprising the step of repeating the method for a plurality of pairs of two primary emission wavelengths.

28. The method of claim 25, 26 or 27, in which the method is a method of calibrating a field-sequential display device comprising a variable-wavelength LED pixel, the variable-wavelength LED pixel being driveable to emit light at any of the N available primary emission wavelengths λ_{P} in response to N respective subfields of driving conditions, the device being driveable to emit different primary emission wavelengths in sequential subframes of a display frame,
in which the N primary emission wavelengths are within an emission wavelength range of the variable-wavelength LED,
the method comprising the step of calculating, for the pair of two selected primary emission wavelengths, the respective luminances which sum to a standard illuminant point;
and controlling the durations of the respective duty cycles of the two subfields of driving conditions so that the selected primary emission wavelengths λ_{P} and luminances of both selected primary emission wavelength subfields are complementary and sum to a standard illuminant point.

29. The method of any of claims 25 to 28, in which the standard illuminant point is a white point.

30. The method of any of claims 25 to 29, in which the standard illuminant point is CIE standard illuminant point D65.

31. The method of any of claims 25 to 30, comprising the step of driving the variable-wavelength LED pixel across the emission wavelength range of the variable-wavelength LED and mapping in a color space the tristimulus coordinates (x, y: chromaticity, and z: luminance) of the variable-wavelength LED across its emission wavelength range.

32. The method of claim 31, in which the tristimulus-coordinates of the variable-wavelength LED are mapped in a CIE xy diagram color space.

33. The method of claim 31, in which the tristimulus-coordinates of the variable-wavelength LED are mapped in perceptually-linear Munsell L*a*b* color space.

34. The method of claim 33, comprising the step of calculating a convex hull of the mapped tristimulus coordinates in perceptually-linear Munsell L*a*b* color space.

35. The method of any of claims 31 to 34, comprising the steps of selecting a first primary wavelength for calibration, the first primary wavelength being a wavelength on the tristimulus coordinates of the variable-wavelength LED, and calculating a first component of a straight line which connects the first primary wavelength for calibration to the standard illuminant point at a constant hue angle.

36. The method of claim 35, comprising the step of intersecting the mapped color space by extending a second component of the straight line at the same constant hue angle from the standard illuminant point to an intersection with the mapped tristimulus coordinates of the variable-wavelength LED, in which the second intersection with the mapped tristimulus coordinates is a second primary emission wavelength complementary to the first primary emission wavelength.

37. The method of any of claim 36, comprising the step of calculating the required colour-mixing ratio required to arrive at the standard illuminant point using the first and second primary emission wavelengths by calculating a ratio of the relative lengths of the first component and the second component of the straight line.

38. The method of claim 37, in which the standard illuminant point is a white point, and the straight line is a white point line.

39. The method of claim 36, 37 or 38, comprising the steps of repeating the steps of claims 35, 36 and optionally 37 for a plurality of pairs of primary emission wavelengths which are complementary to one another.

40. The method of any of claims 25 to 39, comprising the step of calibrating the luminance of the pair of selected primary emission wavelengths by setting the duty cycles for each pair of selected primary emission wavelengths so that the complementary wavelengths and their respective luminances sum to the standard illuminant point.

41. The method of any of claims 25 to 40, comprising the step of calibrating the luminance of the primary emission wavelengths by measuring the emitted luminance as the variable-wavelength LED pixel is driven across its emission wavelength range.

42. The method of any of claims 25 to 41, comprising the steps of:
selecting a maximum emission wavelength usable as a primary emission wavelength within the emission wavelength range of the variable-wavelength LED;
measuring a reference luminance of the variable-wavelength LED at the maximum emission wavelength at 100% duty cycle, in which the variable-wavelength LED is driven to emit light at the maximum emission wavelength for 100% of the duration of a subframe;
calculating, using a colour-mixing ratio and the measured luminance at the maximum emission wavelength, the required luminance at a shorter primary emission wavelength in order to complement the maximum emission wavelength to arrive at the standard illuminant point; and
calculating a duty cycle for the shorter primary emission wavelength which will result in the required luminance from the variable-wavelength LED at the shorter primary emission wavelength.

43. The method of any of claims 25 to 41, comprising the steps of:
for a pair of selected primary emission wavelengths which sum to a standard illuminant point, the pair of selected primary emission wavelengths comprising a longer primary wavelength and a shorter primary wavelength, measuring a reference luminance of the longer of the two primary emission wavelengths at 100% duty cycle, in which the variable-wavelength LED is driven to emit light at the longer primary emission wavelength for 100% of the duration of a subframe;
calculating, using a colour-mixing ratio and the measured luminance of the longer primary emission wavelength, the required luminance at the shorter primary emission wavelength in order to arrive at the standard illuminant point; and
calculating a duty cycle for the shorter primary emission wavelength which will result in the required luminance from the variable-wavelength LED at the shorter primary emission wavelength.
